(19) United States
(12) Patent Application Publication
(10) Pub. No.: US 2024/0313933 A1
(43) Pub. Date: Sep. 19, 2024

(54) COMMUNICATION METHOD, APPARATUS, AND SYSTEM

(71) Applicant: HUAWEI TECHNOLOGIES CO., LTD., Shenzhen (CN)

(72) Inventors: Dongdong Wei, Shanghai (CN); Yongxia Lyu, Shenzhen (CN); Ting Wang, Shanghai (CN)

(73) Assignee: HUAWEI TECHNOLOGIES CO., LTD., Shenzhen (CN)

(21) Appl. No.: 18/669,513

(22) Filed: May 20, 2024

Related U.S. Application Data
(63) Continuation of application No. PCT/CN2022/132646, filed on Nov. 17, 2022.

(30) Foreign Application Priority Data
Nov. 18, 2021 (CN) 202111372467.5

(51) Int. Cl. H04L 5/00; H04W 72/231; H04W 76/15

(52) U.S. Cl. CPC H04L 5/0098; H04L 5/001; H04W 72/231; H04W 76/15

(57) ABSTRACT

An access network device sends, to a terminal device, indication information indicating to shut down one or more carrier groups, where each carrier group includes one or more carriers, so that the terminal device shuts down carriers in M carrier groups based on the indication information. This can reduce a quantity of operating carriers, thereby reducing power consumption.

### CROSS-REFERENCE TO RELATED APPLICATIONS

This application is a continuation of International Application No. PCT/CN2022/132646, filed on Nov. 17, 2022, which claims priority to Chinese Patent Application No.202111372467.5, filed on Nov. 18, 2021. The disclosures of the aforementioned applications are hereby incorporated by reference in their entireties.

### TECHNICAL FIELD

Embodiments of the disclosure relate to the field of communication technologies, and in particular, to a communication method, apparatus, and system.

### BACKGROUND

To meet people's increasingly high traffic requirements, wireless networks are being quickly constructed. In a construction process, with large-scale commercial use of active antenna units (AAUs), a quantity of antennas on an access network device side significantly increases, and consequently power consumption exponentially increases. In addition, to meet a higher data rate and larger traffic, a transmission bandwidth increases, and consequently power consumption increases. Further, with use of millimeter waves and terahertz, sites are densely deployed, and consequently power consumption further increases. Therefore, how to reduce power consumption has become an important problem.

### SUMMARY

Embodiments of the disclosure disclose a communication method, apparatus, and system, to reduce power consumption.

A first aspect discloses a communication method. The communication method may be applied to a terminal device, or may be applied to a module (for example, a chip) in a terminal device. The following uses an example in which the method is applied to the terminal device for description. The communication method may include:
receiving first indication information from an access network device, where the first indication information indicates to shut down M carrier groups, each of the M carrier groups includes one or more carriers, and M is an integer greater than or equal to 1; and
shutting down carriers in the M carrier groups.

In the embodiment of the disclosure, after receiving, from the access network device, the indication information indicating to shut down the M carrier groups, the terminal device may shut down the carriers in the M carrier groups based on the indication information, so that a quantity of operating carriers in a system can be reduced, thereby reducing power consumption.

In an implementation, the communication method may further include:
receiving second indication information from the access network device, where the second indication information indicates a total quantity of carrier groups, and the total quantity is greater than or equal to M.

In the embodiment of the disclosure, the terminal device may receive, from the access network device, the indication information indicating the total quantity of carrier groups, and may then accurately determine, based on the total quantity, the M carrier groups indicated by using the first indication information, to accurately shut down the carriers in the M carrier groups, thereby improving accuracy of shutting down the carriers while reducing power consumption.

In an implementation, the communication method may further include:
receiving third indication information from the access network device, where the third indication information indicates a carrier group corresponding to a first carrier.

In the embodiment of the disclosure, the terminal device may receive, from the access network device, indication information indicating a carrier group corresponding to a carrier, and may then determine, based on the indication information, a carrier group to which each carrier belongs. When subsequently receiving an indication from the access network device to shut down one or more carrier groups, the terminal device can accurately shut down all carriers in the carrier group or these carrier groups based on a carrier group to which a carrier belongs, so that accuracy of shutting down the carriers can be improved.

In an implementation, the third indication information includes an identifier of the carrier group corresponding to the first carrier, and the third indication information is carried in a system message, radio resource control (RRC) signaling, a media access control element (MAC CE), or downlink control information (DCI).

In the embodiment of the disclosure, the indication information indicating a carrier group corresponding to a carrier includes an identifier of the carrier group. The terminal device may determine, based on the identifier, a carrier group to which each carrier belongs, so that when subsequently receiving an indication from the access network device to shut down one or more carrier groups, the terminal device can accurately determine all carriers in the carrier group or these carrier groups based on a carrier group to which a carrier belongs, thereby improving accuracy of shutting down the carriers. In addition, the indication information may be carried in existing signaling or an existing message such as a system message, RRC signaling, a MAC CE, and DCI, and no dedicated message or signaling is needed for transmission, so that compatibility can be improved. When the third indication information is carried in the system message, the third indication information may be sent to the terminal device in a broadcast manner, and the third indication information does not need to be sent to each terminal device, so that an amount of transmitted signaling can be reduced, thereby saving transmission resources. When the third indication information is carried in the RRC signaling, because this message is encrypted and retransmitted, security and reliability can be improved. When the third indication information is carried in the DCI, because it takes short time to send the DCI and take effect, a latency is short. When the third indication information is carried in the MAC CE, a latency and reliability fall between the RRC signaling and the DCI.

In an implementation, the communication method may further include:
receiving configuration information from the access network device, where the configuration information is used to configure a candidate primary component carrier; and
activating the candidate primary component carrier as a primary component carrier when there is a primary component carrier in the carriers included in the M carrier groups that are shut down.

In the embodiment of the disclosure, after the terminal device receives, from the access network device, the configuration information used to configure the candidate primary component carrier, the terminal device may directly activate the candidate primary component carrier as the primary component carrier when there is the primary component carrier in the carriers included in the M carrier groups that are shut down, and the access network device does not need to change or reconfigure the primary component carrier by using a switching command. This can effectively shorten service interruption time and reduce an amount of transmitted information, thereby improving user experience and saving transmission resources.

In an implementation, the candidate primary component carrier is used for a master station or a secondary station.

In the embodiment of the disclosure, the candidate primary component carrier may be used for the master station or the secondary station. This can ensure that the candidate primary component carrier can be directly activated as the primary component carrier regardless of whether a master station primary component carrier is shut down or a secondary station primary component carrier is shut down, and the access network device does not need to change or reconfigure the primary component carrier by using a switching command. This can effectively shorten service interruption time and reduce an amount of transmitted information, thereby improving user experience and saving transmission resources.

In an implementation, the first indication information includes identifiers of the M carrier groups.

In the embodiment of the disclosure, the indication information indicating to shut down the M carrier groups includes the identifiers of the M carrier groups, so that the terminal device may accurately determine all carriers in the M carrier groups based on the identifiers of the M carrier groups, thereby improving accuracy of shutting down the carriers.

In an implementation, the first indication information is carried in a system message, RRC signaling, a MAC CE, or DCI.

In the embodiment of the disclosure, the first indication information may be carried in existing signaling or an existing message such as a system message, RRC signaling, a MAC CE, and DCI, and no dedicated message or signaling is needed for transmission, so that compatibility can be improved.

In an implementation, the MAC CE corresponds to a predefined logical channel identifier (LCID).

In the embodiment of the disclosure, the MAC CE used to transmit the first indication information has a dedicated LCID, so that the terminal device may quickly and accurately identify, based on the LCID, whether there is the MAC CE indicating to shut down the carrier groups.

In an implementation, the carrier included in the carrier group is associated with one or more radio access technologies (RATs).

In the embodiment of the disclosure, carriers corresponding to a same RAT or different RATs may be indicated by using same indication information, so that a case in which the carriers corresponding to the different RATs are indicated by using different indication information can be avoided, thereby reducing an amount of indication information. Therefore, transmission resources can be saved.

In an implementation, at least one of the M carrier groups includes a plurality of carriers.

In the embodiment of the disclosure, a plurality of carriers may be indicated by using one carrier group, so that an amount of information that needs to be indicated in the indication information can be reduced, and resource utilization can be improved.

In an implementation, that the terminal device receives first indication information from an access network device may include:
receiving the first indication information from the access network device in a multicast manner or a broadcast manner.

In the embodiment of the disclosure, the indication information indicating to shut down the M carrier groups may be transmitted in the multicast or broadcast manner, so that a case in which different terminal devices can be separately indicated can be avoided, and an amount of transmitted information can be reduced, thereby saving transmission resources.

In an implementation, that the terminal device receives first indication information from an access network device may include:
receiving the first indication information from the access network device in a unicast manner.

In an implementation, carriers in a same carrier group belong to a same power amplifier (PA) or band.

In the embodiment of the disclosure, when the carriers in the same carrier group belong to the same PA, the PA may be further shut down by shutting down the carriers in the PA. Due to high power consumption of the PA, power consumption can be further reduced.

In an implementation, the communication method may further include:
receiving fourth indication information from the access network device, where the fourth indication information indicates to enable N carrier groups, and N is an integer greater than or equal to 1; and
enabling carriers corresponding to the N carrier groups.

In the embodiment of the disclosure, after receiving, from the access network device, the indication information indicating to enable the N carrier groups, the terminal device may enable the carriers in the N carrier groups based on the indication information, to ensure normal running of a service.

A second aspect discloses a communication method. The communication method may be applied to an access network device, or may be applied to a module (for example, a chip) in an access network device. The following provides descriptions by using an example in which the method is applied to the access network device. The communication method may include:
sending first indication information, where the first indication information indicates to shut down M carrier groups, each of the M carrier groups includes one or more carriers, and M is an integer greater than or equal to 1.

In the embodiment of the disclosure, the access network device may send, to the terminal device, the indication information indicating to shut down the M carrier groups, so that the terminal device may shut down the carriers in the M carrier groups based on the indication information. This can reduce a quantity of operating carriers in a system, thereby reducing power consumption. In an implementation, the communication method may further include:
sending second indication information, where the second indication information indicates a total quantity of carrier groups, and the total quantity is greater than or equal to M.

In the embodiment of the disclosure, the access network device may send, to the terminal device, the indication information indicating the total quantity of carrier groups, so that the terminal device may accurately determine, based on the total quantity, the M carrier groups indicated by using the first indication information, to accurately shut down the carriers in the M carrier groups, thereby improving accuracy of shutting down the carriers while reducing power consumption.

In an implementation, the communication method may further include:
sending third indication information, where the third indication information indicates a carrier group corresponding to a first carrier.

In the embodiment of the disclosure, the access network device may send, to the terminal device, indication information indicating a carrier group corresponding to a carrier, so that the terminal device may determine, based on the indication information, a carrier group to which each carrier belongs. When subsequently receiving an indication from the access network device to shut down one or more carrier groups, the terminal device can accurately shut down all carriers in the carrier group or these carrier groups based on a carrier group to which a carrier belongs, so that accuracy of shutting down the carriers can be improved.

In an implementation, the third indication information includes an identifier of the carrier group corresponding to the first carrier, and the third indication information is carried in a system message, RRC signaling, a MAC CE, or DCI.

In the embodiment of the disclosure, the indication information indicating a carrier group corresponding to a carrier includes an identifier of the carrier group, so that the terminal device may determine, based on the identifier of the carrier group, a carrier group to which each carrier belongs. When subsequently receiving an indication from the access network device to shut down one or more carrier groups, the terminal device can accurately determine all carriers in the carrier group or these carrier groups based on a carrier group to which a carrier belongs, so that accuracy of shutting down the carriers can be improved. In addition, the indication information may be carried in existing signaling or an existing message such as a system message, RRC signaling, a MAC CE, and DCI, and no dedicated message or signaling is needed for transmission, so that compatibility can be improved.

In an implementation, the communication method may further include:
sending configuration information, where the configuration information is used to configure a candidate primary component carrier.

In the embodiment of the disclosure, the access network device may send, to the terminal device, the configuration information used to configure the candidate primary component carrier, so that the terminal device may directly activate the candidate primary component carrier as a primary component carrier when there is a primary component carrier in the carriers included in the M carrier groups that are shut down, and the access network device does not need to change or reconfigure the primary component carrier by using a switching command. This can effectively shorten service interruption time and reduce an amount of transmitted information, thereby improving user experience and saving transmission resources.

In an implementation, the candidate primary component carrier is used for a master station or a secondary station.

In the embodiment of the disclosure, the configured candidate primary component carrier may be used for the master station or the secondary station. This can ensure that the candidate primary component carrier can be directly activated as the primary component carrier regardless of whether a master station primary component carrier is shut down or a secondary station primary component carrier is shut down, and the access network device does not need to change or reconfigure the primary component carrier by using a switching command. This can effectively shorten service interruption time and reduce an amount of transmitted information, thereby improving user experience and saving transmission resources.

In an implementation, the first indication information includes identifiers of the M carrier groups.

In the embodiment of the disclosure, the indication information indicating to shut down the M carrier groups includes the identifiers of the M carrier groups, so that the terminal device may accurately determine all carriers in the M carrier groups based on the identifiers of the M carrier groups, thereby improving accuracy of shutting down the carriers.

In an implementation, the first indication information is carried in a system message, RRC signaling, a MAC CE, or DCI.

In the embodiment of the disclosure, the first indication information may be carried in existing signaling or an existing message such as a system message, RRC signaling, a MAC CE, and DCI, and no dedicated message or signaling is needed for transmission, so that compatibility can be improved. In an implementation, the MAC CE corresponds to a predefined LCID.

In the embodiment of the disclosure, the MAC CE used to transmit the first indication information has a dedicated LCID, so that the terminal device may quickly and accurately identify, based on the LCID, whether there is the MAC CE indicating to shut down the M carrier groups.

In an implementation, the carrier included in the carrier group is associated with one or more RATs.

In the embodiment of the disclosure, carriers corresponding to a same RAT or different RATs may be indicated by using same indication information, so that a case in which the carriers corresponding to the different RATs are indicated by using different indication information can be avoided, thereby reducing an amount of indication information. Therefore, transmission resources can be saved.

In an implementation, at least one of the M carrier groups includes a plurality of carriers.

In the embodiment of the disclosure, a plurality of carriers may be indicated by using one carrier group, so that an amount of information that needs to be indicated in the indication information can be reduced, and resource utilization can be improved.

In an implementation, that the access network device sends first indication information includes:
sending the first indication information in a multicast manner or a broadcast manner.

In the embodiment of the disclosure, the indication information indicating to shut down the M carrier groups may be transmitted in the multicast or broadcast manner, so that a case in which different terminal devices can be separately indicated can be avoided, and an amount of transmitted information can be reduced, thereby saving transmission resources.

In an implementation, that the access network device sends first indication information includes:
sending the first indication information to the terminal device in a unicast manner.

In an implementation, carriers in a same carrier group belong to a same PA or band.

In the embodiment of the disclosure, when the carriers in the same carrier group belong to the same PA, the PA may be further shut down by shutting down the carriers in the PA. Due to high power consumption of the PA, power consumption can be further reduced.

In an implementation, the communication method may further include:
sending fourth indication information, where the fourth indication information indicates to enable N carrier groups, and N is an integer greater than or equal to 1.

In the embodiment of the disclosure, the access network device may send, to the terminal device, the indication information indicating to enable the N carrier groups, so that the terminal device may enable carriers in the N carrier groups based on the indication information, to ensure normal running of a service.

A third aspect discloses a communication method. The communication method may be applied to a terminal device, or may be applied to a module (for example, a chip) in a terminal device. The following uses an example in which the method is applied to the terminal device for description. The communication method may include:
receiving first indication information from an access network device, where the first indication information indicates to shut down M carriers, the M carriers are associated with one or more RATs, and M is an integer greater than or equal to 1; and
shutting down the M carriers.

In the embodiment of the disclosure, after receiving, from the access network device, the indication information indicating to shut down the M carriers, the terminal device may shut down the M carriers based on the indication information, so that a quantity of operating carriers in a system can be reduced, thereby reducing power consumption. In addition, a plurality of carriers corresponding to a same RAT or different RATs may be indicated by using same indication information, so that a case in which the carriers corresponding to the different RATs or different carriers are indicated by using different indication information can be avoided, thereby reducing an amount of indication information. Therefore, transmission resources can be saved.

In an implementation, the communication method may further include:
receiving second indication information from the access network device, where the second indication information indicates a total quantity of carriers, and the total quantity is greater than or equal to M.

In the embodiment of the disclosure, the terminal device may receive, from the access network device, the indication information indicating the total quantity of carriers, and may then accurately determine, based on the total quantity, the M carriers indicated by using the first indication information, to accurately shut down the M carriers, thereby improving accuracy of shutting down the carriers while reducing power consumption.

In an implementation, the communication method may further include:
receiving configuration information from the access network device, where the configuration information is used to configure a candidate primary component carrier; and
activating the candidate primary component carrier as a primary component carrier when there is a primary component carrier in the M carriers that are shut down.

In the embodiment of the disclosure, after the terminal device receives, from the access network device, the configuration information used to configure the candidate primary component carrier, the terminal device may directly activate the candidate primary component carrier as the primary component carrier when there is the primary component carrier in the M carrier groups that are shut down, and the access network device does not need to change or reconfigure the primary component carrier by using a switching command. This can effectively shorten service interruption time and reduce an amount of transmitted information, thereby improving user experience and saving transmission resources.

In an implementation, the candidate primary component carrier is used for a master station or a secondary station.

In the embodiment of the disclosure, the candidate primary component carrier may be used for the master station or the secondary station. This can ensure that the candidate primary component carrier can be directly activated as the primary component carrier regardless of whether a master station primary component carrier is shut down or a secondary station primary component carrier is shut down, and the access network device does not need to change or reconfigure the primary component carrier by using a switching command. This can effectively shorten service interruption time and reduce an amount of transmitted information, thereby improving user experience and saving transmission resources.

In an implementation, the first indication information includes identifiers of the M carriers, and the identifiers of the carriers are numbers obtained after the access network device uniformly numbers all the carriers.

In the embodiment of the disclosure, the indication information indicating to shut down the M carriers includes the identifiers of the M carriers, so that the terminal device may accurately determine the M carriers based on the identifiers of the M carriers, thereby improving accuracy of shutting down the carriers.

In an implementation, the first indication information is carried in a system message, RRC signaling, a MAC CE, or DCI.

In the embodiment of the disclosure, the first indication information may be carried in existing signaling or an existing message such as a system message, RRC signaling, a MAC CE, and DCI, and no dedicated message or signaling is needed for transmission, so that compatibility can be improved.

In an implementation, the MAC CE corresponds to a predefined LCID.

In the embodiment of the disclosure, the MAC CE used to transmit the first indication information has a dedicated LCID, so that the terminal device may quickly and accurately identify, based on the LCID, whether there is the MAC CE indicating to shut down the M carriers.

In an implementation, that the terminal device receives first indication information from an access network device may include:
receiving the first indication information from the access network device in a multicast manner or a broadcast manner.

In the embodiment of the disclosure, the indication information indicating to shut down the M carriers may be transmitted in the multicast or broadcast manner, so that a case in which different terminal devices can be separately indicated can be avoided, and an amount of transmitted information can be reduced, thereby saving transmission resources.

In an implementation, that the terminal device receives first indication information from an access network device may include:
receiving the first indication information from the access network device in a unicast manner.

In an implementation, the communication method may further include:
receiving third indication information from the access network device, where the third indication information indicates to enable N carriers, and N is an integer greater than or equal to 1; and
enabling the N carriers.

In the embodiment of the disclosure, after receiving, from the access network device, the indication information indicating to enable the N carriers, the terminal device may enable the N carriers based on the indication information, to ensure normal running of a service.

A fourth aspect discloses a communication method. The communication method may be applied to an access network device, or may be applied to a module (for example, a chip) in an access network device. The following uses an example in which the method is applied to the access network device for description. The communication method may include:
sending first indication information, where the first indication information indicates to shut down M carriers, the M carriers are associated with one or more RATs, and M is an integer greater than or equal to 1.

In the embodiment of the disclosure, the access network device may send, to the terminal device, the indication information indicating to shut down the M carriers, so that the terminal device may shut down the M carriers based on the indication information. This can reduce a quantity of operating carriers in a system, thereby reducing power consumption. In addition, a plurality of carriers corresponding to a same RAT or different RATs may be indicated by using same indication information, so that a case in which the carriers corresponding to the different RATs or different carriers are indicated by using different indication information can be avoided, thereby reducing an amount of indication information. Therefore, transmission resources can be saved.

In an implementation, the communication method may further include:
sending second indication information, where the second indication information indicates a total quantity of carriers, and the total quantity is greater than or equal to M.

In the embodiment of the disclosure, the access network device may send, to the terminal device, the indication information indicating the total quantity of carriers, so that the terminal device may accurately determine, based on the total quantity, the M carriers indicated by using the first indication information, to accurately shut down the M carriers, thereby improving accuracy of shutting down the carriers while reducing power consumption.

In an implementation, the communication method may further include:
sending configuration information, where the configuration information is used to configure a candidate primary component carrier.

In the embodiment of the disclosure, the access network device may send, to the terminal device, the configuration information used to configure the candidate primary component carrier, so that the terminal device may directly activate the candidate primary component carrier as a primary component carrier when there is a primary component carrier in the M carriers that are shut down, and the access network device does not need to change or reconfigure the primary component carrier by using a switching command. This can effectively shorten service interruption time and reduce an amount of transmitted information, thereby improving user experience and saving transmission resources.

In an implementation, the candidate primary component carrier is used for a master station or a secondary station.

In the embodiment of the disclosure, the configured candidate primary component carrier may be used for the master station or the secondary station. This can ensure that the candidate primary component carrier can be directly activated as the primary component carrier regardless of whether a master station primary component carrier is shut down or a secondary station primary component carrier is shut down, and the access network device does not need to change or reconfigure the primary component carrier by using a switching command. This can effectively shorten service interruption time and reduce an amount of transmitted information, thereby improving user experience and saving transmission resources.

In an implementation, the first indication information includes identifiers of the M carriers, and the identifiers of the carriers are numbers obtained after the access network device uniformly numbers all the carriers.

In the embodiment of the disclosure, the indication information indicating to shut down the M carriers includes the identifiers of the M carriers, so that the terminal device may accurately determine the M carriers based on the identifiers of the M carriers, thereby improving accuracy of shutting down the carriers.

In an implementation, the first indication information is carried in a system message, RRC signaling, a MAC CE, or DCI.

In the embodiment of the disclosure, the first indication information may be carried in existing signaling or an existing message such as a system message, RRC signaling, a MAC CE, and DCI, and no dedicated message or signaling is needed for transmission, so that compatibility can be improved.

In an implementation, the MAC CE corresponds to a predefined LCID.

In the embodiment of the disclosure, the MAC CE used to transmit the first indication information has a dedicated LCID, so that the terminal device may quickly and accurately identify, based on the LCID, whether there is the MAC CE indicating to shut down the M carriers.

In an implementation, that the access network device sends first indication information includes:
sending the first indication information in a multicast manner or a broadcast manner.

In the embodiment of the disclosure, the indication information indicating to shut down the M carriers may be transmitted in the multicast or broadcast manner, so that a case in which different terminal devices can be separately indicated can be avoided, and an amount of transmitted information can be reduced, thereby saving transmission resources.

In an implementation, that the access network device sends first indication information includes:
sending the first indication information to the terminal device in a unicast manner.

In an implementation, the communication method may further include:
sending third indication information, where the third indication information indicates to enable N carriers, and N is an integer greater than or equal to 1.

In the embodiment of the disclosure, the access network device may send, to the terminal device, the indication information indicating to enable the N carriers, so that the terminal device may enable the N carriers based on the indication information, to ensure normal running of a service.

A fifth aspect discloses a communication apparatus. The communication apparatus may be a terminal device, or may be a module (for example, a chip) in a terminal device. The communication apparatus may include:
a receiving unit, configured to receive first indication information from an access network device, where the first indication information indicates to shut down M carrier groups, each of the M carrier groups includes one or more carriers, and M is an integer greater than or equal to 1; and
a shutdown unit, configured to shut down carriers in the M carrier groups.

In an implementation, the receiving unit is further configured to receive second indication information from the access network device, where the second indication information indicates a total quantity of carrier groups, and the total quantity is greater than or equal to M.

In an implementation, the receiving unit is further configured to receive third indication information from the access network device, where the third indication information indicates a carrier group corresponding to a first carrier.

In a possible implementation, the third indication information includes an identifier of the carrier group corresponding to the first carrier, and the third indication information is carried in a system message, RRC signaling, a MAC CE, or DCI.

In an implementation, the receiving unit is further configured to receive configuration information from the access network device, where the configuration information is used to configure a candidate primary component carrier.

The communication apparatus may further include:
an activation unit, configured to activate the candidate primary component carrier as a primary component carrier when there is a primary component carrier in the carriers included in the M carrier groups that are shut down.

In an implementation, the candidate primary component carrier is used for a master station or a secondary station.

In an implementation, the first indication information includes identifiers of the M carrier groups.

In an implementation, the first indication information is carried in a system message, RRC signaling, a MAC CE, or DCI.

In an implementation, the MAC CE corresponds to a predefined LCID.

In a possible implementation, the carrier included in the carrier group is associated with one or more RATs.

In an implementation, at least one of the M carrier groups includes a plurality of carriers.

In an implementation, that a receiving unit receives first indication information from an access network device may include:
receiving the first indication information from the access network device in a multicast manner or a broadcast manner.

In an implementation, that a receiving unit receives first indication information from an access network device may include:
receiving the first indication information from the access network device in a unicast manner.

In an implementation, carriers in a same carrier group belong to a same PA or band.

In an implementation, the receiving unit is further configured to receive fourth indication information from the access network device, where the fourth indication information indicates to enable N carrier groups, and N is an integer greater than or equal to 1.

The communication apparatus may further include:
an enabling unit, configured to enable carriers corresponding to the N carrier groups.

A sixth aspect discloses a communication apparatus. The communication apparatus may be an access network device, or may be a module (for example, a chip) in an access network device. The communication apparatus may include:
a sending unit, configured to send first indication information, where the first indication information indicates to shut down M carrier groups, each of the M carrier groups includes one or more carriers, and M is an integer greater than or equal to 1.

In an implementation, the sending unit is further configured to send second indication information, where the second indication information indicates a total quantity of carrier groups, and the total quantity is greater than or equal to M.

In an implementation, the sending unit is further configured to send third indication information, where the third indication information indicates a carrier group corresponding to a first carrier.

In an implementation, the third indication information includes an identifier of the carrier group corresponding to the first carrier, and the third indication information is carried in a system message, RRC signaling, a MAC CE, or DCI.

In an implementation, the sending unit is further configured to send configuration information, where the configuration information is used to configure a candidate primary component carrier.

In an implementation, the candidate primary component carrier is used for a master station or a secondary station.

In an implementation, the first indication information includes identifiers of the M carrier groups.

In an implementation, the first indication information is carried in a system message, RRC signaling, a MAC CE, or DCI.

In an implementation, the MAC CE corresponds to a predefined LCID.

In an implementation, the carrier included in the carrier group is associated with one or more RATs.

In an implementation, at least one of the M carrier groups includes a plurality of carriers.

In an implementation, that a sending unit sends first indication information includes: sending the first indication information in a multicast manner or a broadcast manner.

In an implementation, that a sending unit sends first indication information includes:
sending the first indication information to the terminal device in a unicast manner.

In an implementation, carriers in a same carrier group belong to a same PA or band.

In an implementation, the sending unit is further configured to send fourth indication information, where the fourth indication information indicates to enable N carrier groups, and Nis an integer greater than or equal to 1.

A seventh aspect discloses a communication apparatus. The communication apparatus may be a terminal device, or may be a module (for example, a chip) in a terminal device. The communication apparatus may include:
a receiving unit, configured to receive first indication information from an access network device, where the first indication information indicates to shut down M carriers, the M carriers are associated with one or more RATs, and M is an integer greater than or equal to 1; and
a shutdown unit, configured to shut down the M carriers.

In an implementation, the receiving unit is further configured to receive second indication information from the access network device, where the second indication information indicates a total quantity of carriers, and the total quantity is greater than or equal to M.

In an implementation, the receiving unit is further configured to receive configuration information from the access network device, where the configuration information is used to configure a candidate primary component carrier.

The communication apparatus may further include:
an activation unit, configured to activate the candidate primary component carrier as a primary component carrier when there is a primary component carrier in the M carriers that are shut down.

In an implementation, the candidate primary component carrier is used for a master station or a secondary station.

In an implementation, the first indication information includes identifiers of the M carriers, and the identifiers of the carriers are numbers obtained after the access network device uniformly numbers all the carriers.

In an implementation, the first indication information is carried in a system message, RRC signaling, a MAC CE, or DCI.

In an implementation, the MAC CE corresponds to a predefined LCID.

In an implementation, that a receiving unit receives first indication information from an access network device may include:
receiving the first indication information from the access network device in a multicast manner or a broadcast manner.

In an implementation, that a receiving unit receives first indication information from an access network device may include:
receiving the first indication information from the access network device in a unicast manner.

In an implementation, the receiving unit is further configured to receive third indication information from the access network device, where the third indication information indicates to enable N carriers, and N is an integer greater than or equal to 1.

The communication apparatus may further include:
an enabling unit, configured to enable the N carriers.

An eighth aspect discloses a communication apparatus. The communication apparatus may be an access network device, or may be a module (for example, a chip) in an access network device. The communication apparatus may include:
a sending unit, configured to send first indication information, where the first indication information indicates to shut down M carriers, the M carriers are associated with one or more RATs, and M is an integer greater than or equal to 1.

In an implementation, the sending unit is further configured to send second indication information, where the second indication information indicates a total quantity of carriers, and the total quantity is greater than or equal to M.

In an implementation, the sending unit is further configured to send configuration information, where the configuration information is used to configure a candidate primary component carrier.

In an implementation, the candidate primary component carrier is used for a master station or a secondary station.

In an implementation, the first indication information includes identifiers of the M carriers, and the identifiers of the carriers are numbers obtained after the access network device uniformly numbers all the carriers.

In an implementation, the first indication information is carried in a system message, RRC signaling, a MAC CE, or DCI.

In an implementation, the MAC CE corresponds to a predefined LCID.

In an implementation, that a sending unit sends first indication information includes: sending the first indication information in a multicast manner or a broadcast manner.

In an implementation, that a sending unit sends first indication information includes: sending the first indication information to the terminal device in a unicast manner.

In an implementation, the sending unit is further configured to send third indication information, where the third indication information indicates to enable N carriers, and Nis an integer greater than or equal to 1.

A ninth aspect discloses a communication apparatus. The communication apparatus may include a processor coupled to a memory, and the processor invokes a computer program stored in the memory to implement the communication method according to any one of the first aspect or the implementations of the first aspect (or any one of the third aspect or the implementations of the third aspect).

In an implementation, the communication apparatus may further include a memory.

In an implementation, the communication apparatus may further include a transceiver. The transceiver is configured to: receive information from another communication apparatus other than the communication apparatus, and output information to the another communication apparatus other than the communication apparatus.

A tenth aspect discloses a communication apparatus. The communication apparatus may include a processor coupled to a memory, and the processor invokes a computer program stored in the memory to implement the communication method according to any one of the second aspect or the implementations of the second aspect (or any one of the fourth aspect or the implementations of the fourth aspect).

In an implementation, the communication apparatus may further include a memory.

In an implementation, the communication apparatus may further include a transceiver. The transceiver is configured to: receive information from another communication apparatus other than the communication apparatus, and output information to the another communication apparatus other than the communication apparatus.

An eleventh aspect discloses a communication system. The communication system includes the communication apparatus according to the ninth aspect and the communication apparatus according to the tenth aspect.

A twelfth aspect discloses a computer-readable storage medium. The computer-readable storage medium stores a computer program or computer instructions, and when the computer program or the computer instructions are run on a computer, the communication methods according to the foregoing aspects are performed.

A thirteenth aspect discloses a chip, including: a processor, configured to execute a computer program stored in a memory. When the computer program is executed, the chip is enabled to perform the foregoing methods.

In an implementation, the memory is located outside the chip.

A fourteenth aspect discloses a computer program product. The computer program product includes a computer program or computer instructions, and when the computer program or the computer instructions are run on a computer, the communication methods are performed.

It may be understood that the communication apparatuses disclosed in the fifth aspect, the sixth aspect, the seventh aspect, the eighth aspect, the ninth aspect, and the tenth aspect, the communication system disclosed in the eleventh aspect, the computer-readable storage medium disclosed in the twelfth aspect, the chip disclosed in the thirteenth aspect, and the computer program product disclosed in the fourteenth aspect are all configured to perform the method disclosed in any one of the first aspect and the implementations of the first aspect, or the method disclosed in any one of the second aspect and the implementations of the second aspect, the method disclosed in any one of the third aspect and the implementations of the third aspect, or the method disclosed in any one of the fourth aspect and the implementations of the fourth aspect in the disclosure. Therefore, for beneficial effects that can be achieved, refer to beneficial effects in the corresponding method. Details are not described herein again.

### BRIEF DESCRIPTION OF DRAWINGS

To describe technical solutions in embodiments of the disclosure more clearly, the following briefly describes the accompanying drawings for describing embodiments.

FIG. 1 is a diagram of a network architecture according to an embodiment of the disclosure;

FIG. 2 is a diagram of a standalone scenario according to an embodiment of the disclosure;

FIG. 3 is a diagram of a dual connectivity scenario according to an embodiment of the disclosure;

FIG. 4 is a diagram of a master cell group and a secondary cell group according to an embodiment of the disclosure;

FIG. 5 is a diagram of a special cell according to an embodiment of the disclosure;

FIG. 6 is a diagram of a media access control element indication according to an embodiment of the disclosure;

FIG. 7 is an interaction diagram of a communication method according to an embodiment of the disclosure;

FIG. 8 is a diagram of a bitmap according to an embodiment of the disclosure;

FIG. 9 is a diagram of another bitmap according to an embodiment of the disclosure;

FIG. 10 is a diagram of still another bitmap according to an embodiment of the disclosure;

FIG. 11 is a diagram of a type of first indication information according to an embodiment of the disclosure;

FIG. 12 is a diagram of another type of first indication information according to an embodiment of the disclosure;

FIG. 13 is a diagram of dividing carrier groups based on amplifiers according to an embodiment of the disclosure;

FIG. 14 is a interaction diagram of another communication method according to an embodiment of the disclosure;

FIG. 15 is a interaction diagram of still another communication method according to an embodiment of the disclosure;

FIG. 16 is a interaction diagram of yet another communication method according to an embodiment of the disclosure;

FIG. 17 is a diagram of a structure of a communication apparatus according to an embodiment of the disclosure;

FIG. 18 is a diagram of a structure of another communication apparatus according to an embodiment of the disclosure;

FIG. 19 is a diagram of a structure of still another communication apparatus according to an embodiment of the disclosure; and

FIG. 20 is a diagram of a structure of yet another communication apparatus according to an embodiment of the disclosure.

### DESCRIPTION OF EMBODIMENTS

Embodiments of the disclosure disclose a communication method, apparatus, and system, to reduce power consumption. Details are separately described below.

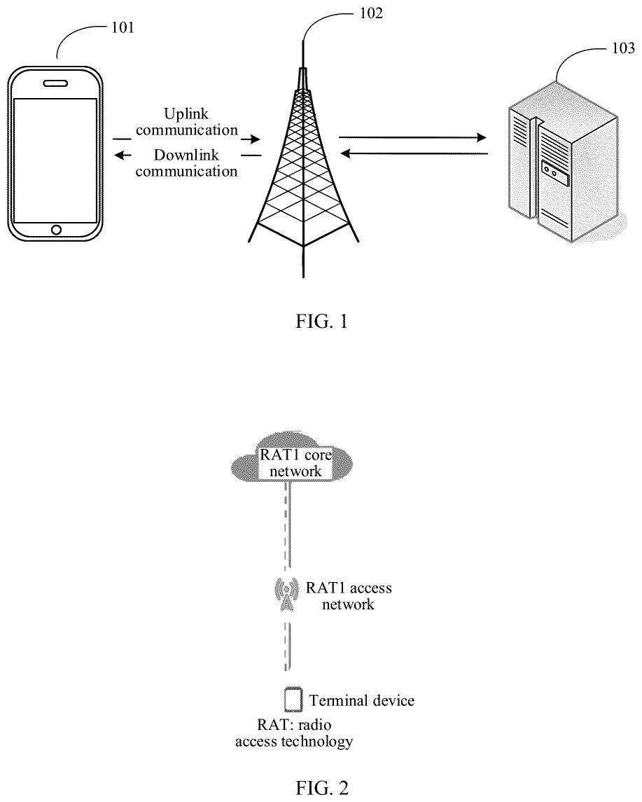

To better understand a communication method, apparatus, and system disclosed in embodiments of the disclosure, the following first describes a network architecture used in embodiments of the disclosure. FIG. 1 is a diagram of a network architecture according to an embodiment of the disclosure. As shown in FIG. 1, the network structure may include a terminal device 101, an access network device 102, and a core network device 103. Communication between the terminal device 101 and the access network device 102 may include uplink communication (namely, communication between the terminal device 101 and the access network device 102) and downlink communication (namely, communication between the access network device 102 and the terminal device 101). In the uplink communication, the terminal device 101 is configured to send an uplink signal to the access network device 102; and the access network device 102 is configured to receive the uplink signal from the terminal device 101. In the downlink communication, the access network device 102 is configured to send a downlink signal to the terminal device 101; and the terminal device 101 is configured to receive the downlink signal from the access network device 102. The core network device 103 communicates with the access network device 102.

The terminal device, which may also be referred to as UE, a mobile station (MS), a mobile terminal (MT), or the like, is a device that provides voice and/or data connectivity for a user. The terminal device may be a handheld terminal, customer premises equipment (CPE), a notebook computer, a subscriber unit, a cellular phone, a smartphone, a wireless data card, a personal digital assistant (PDA) computer, a tablet computer, a wireless modem, a handheld device, a laptop computer, a session initiation protocol (SIP) phone, a cordless telephone or a wireless local loop (WLL) station, a machine type communication (MTC) terminal, a wearable device (such as a smart watch, a smart band, or a pedometer), a vehicle-mounted device (such as a car, a bicycle, an electric vehicle, an airplane, a ship, a train, or a high-speed railway), a virtual reality (VR) device, an augmented reality (AR) device, a wireless terminal in industrial control, a smart home device (such as a refrigerator, a television, an air conditioner, or an electric meter), a smart robot, a workshop device, a wireless terminal in self driving, a wireless terminal in remote medical surgery, a wireless terminal in a smart grid, a wireless terminal in transportation safety, a wireless terminal in a smart city, a wireless terminal in a smart home, a flight device (such as an intelligent robot, a hot air balloon, an unmanned aerial vehicle, or an airplane), or another device that can access a network.

The access network device is a device that provides radio access for the terminal device, and is mainly responsible for functions such as radio resource management, quality of service (QOS) flow management, and data compression and encryption on an air interface side. The access network device may include base stations in various forms, for example, a macro base station, a micro base station (also referred to as a small cell), a relay station, an access point, and the like. The access network device may further include an evolved NodeB (eNB, or eNodeB) in long term evolution (LTE), a base station gNB in a 5G network, a base station in a future evolved public land mobile network (PLMN), a broadband network gateway (BNG), an aggregation switch, a non-3rd generation partnership project access device, a wireless fidelity (Wi-Fi) access point (AP), a transmission reception point (TRP), a transmission point (TP), a mobile switching center, a device that functions as a base station in device-to-device (D2D), vehicle-to-everything (V2X), or machine-to-machine (M2M) communication, and the like.

The core network device is a device in a core network (CN) that provides service support for the terminal device. The core network device may correspond to different devices in different communication systems. For example, in a 4th generation (4G) mobile communication technology, the core network device may correspond to one or more of a mobility management entity (MME), a serving gateway (S-GW), and the like. For another example, in 5G, the core network device may correspond to one or more network elements of an access and mobility management function (AMF) network element, a session management function (SMF) network element, a user plane function (UPF) network element, and the like. The core network device may be one or more network elements, devices, or entities that may provide service support for the terminal device in a next-generation communication system or a future communication device.

It should be noted that the network architecture shown in FIG. 1 is not limited to including only the terminal device, the access network device, and the core network device shown in the figure, and may further include another terminal device, access network device, and core network device that are not shown in the figure. Details are not described herein in the disclosure one by one.

The technical solutions in the disclosure may be applied to a 3^{rd} generation partnership project (3GPP)-related cellular system, for example, a 4G communication system such as an LTE system, a 5G communication system such as a new radio (NR) system, or a communication system evolved after 5G such as a 6th generation (6G) mobile communication technology, or may be applied to a wireless fidelity (Wi-Fi) system, a communication system that supports convergence of a plurality of wireless technologies, or a future-oriented evolved system.

To better understand a communication method, apparatus, and system disclosed in embodiments of the disclosure, the following first describes a disclosure scenario used in an embodiment of the disclosure. In a standalone (SA) scenario, the terminal device is connected to a single access network device. The access network device connected to the terminal device and the core network device connected to the access network device are of a same standard. That is, the access network device and the core network device are of the same standard. FIG. 2 is a diagram of a standalone scenario according to an embodiment of the disclosure. As shown in FIG. 2, standards of both an access network device connected to a terminal device and a core network device are a RAT1. The RAT1 may be LTE, 5G, 6G, or a future-oriented radio access technology.

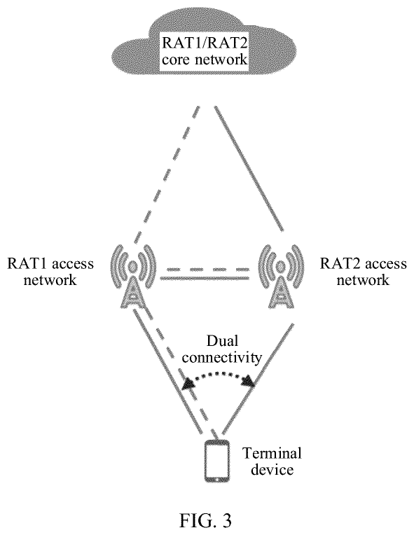

In a dual connectivity (DC) scenario, the terminal device may be connected to both two access networks, and standards of the two access networks may be the same or different. The two access networks are connected to a same core network, and a standard of the core network is the same as that of at least one of the two access networks. FIG. 3 is a diagram of a DC scenario according to an embodiment of the disclosure. As shown in FIG. 3, a terminal device may be connected to both a RAT1 access network and a RAT2 access network. Both the RAT1 access network and the RAT2 access network may be connected to a RAT1 core network or a RAT2 core network. A RAT1 and a RAT2 may be different. In this case, the RAT1 access network may be used as a master station (or a secondary station), and the RAT2 access network may be used as a secondary station (or a master station). A RAT1 and a RAT2 may be the same. In this case, a master station and a secondary station are the same.

For example, the core network may be a 5G core network, the two access networks may respectively be a 5G access network and a 6G access network, the 5G access network may be used as a master station (or a secondary station), and the 6G access network may be used as a secondary station (or a master station). For another example, the core network may be a 6G core network, the two access networks may respectively be a 5G access network and a 6G access network, the 6G access network may be used as a master station (or a master station), and the 5G access network may be used as a secondary station (or a master station). For another example, the core network may be a 5G core network, the two access networks may both be a 5G access network, and a master station and a secondary station both are the 5G access network. For another example, the core network may be a 6G core network, the two access networks may both be a 6G access network, and a master station and a secondary station both are the 6G access network.

To better understand embodiments of the disclosure, the following first describes related concepts or terms.

A master cell group (MCG) is a group of serving cells associated with a master node (namely, a master station), and may include a primary cell (PCell). In addition, the MCG may further include one or more secondary cells (SCells).

The master node is a radio access node that provides a control plane connection for the core network in multi-radio dual connectivity (multi-RAT DC or MR-DC).

A secondary cell group (SCG) is a group of serving cells associated with a secondary node (namely, a secondary station), and may include a primary secondary cell (PSCell). In addition, the SCG may further include one or more SCells.

The secondary node is a radio access node that has no control plane connection to the core network and that provides an additional resource for the terminal device in an MR-DC case. The PCell is a cell to which the terminal device initiates initial access in the MCG.

The PSCell is a cell to which the terminal device initiates initial access in the SCG.

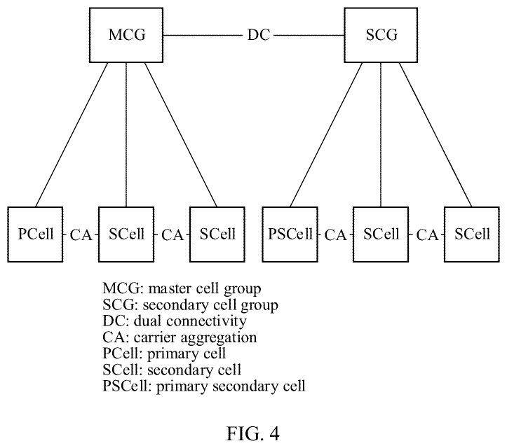

FIG. 4 is a diagram of an MCG and an SCG according to an embodiment of the disclosure. As shown in FIG. 4, a PCell and an SCell included in the MCG may be combined by using a carrier aggregation (CA) technology. Similarly, a PSCell and an SCell included in the SCG may also be combined by using the CA technology.

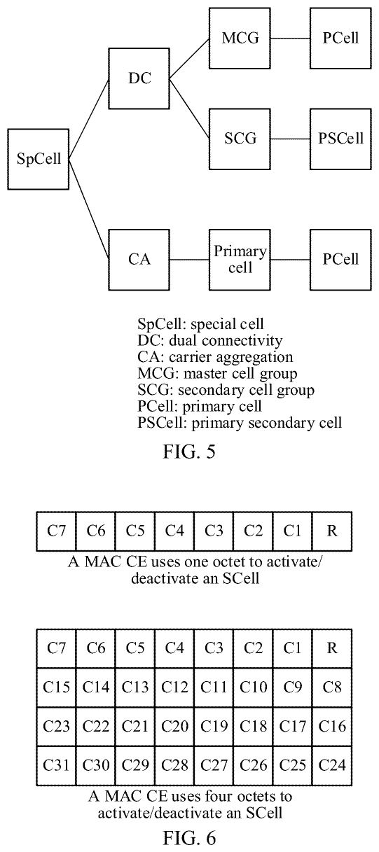

FIG. 5 is a diagram of a special cell (SpCell) according to an embodiment of the disclosure. As shown in FIG. 5, in a DC scenario, the SpCell may be a PCell in an MCG, or may be a PSCell in an SCG. In a non-DC scenario, the SpCell may be a PCell.

To better understand embodiments of the disclosure, the following first describes conventional technologies in embodiments of the disclosure.

To meet people's increasingly high traffic requirements, wireless networks are always being quickly constructed. As a network scale increases, power consumption continuously increases, and electricity expenses greatly increase operators' costs. Main causes for increasing the power consumption are as follows.

1. With large-scale commercial use of AAUs, a quantity of antennas on an access network device side significantly increases, and power consumption exponentially increases compared with that in 3G and 4G eras.

2. Because a higher data rate and larger traffic need to be supported, more transmission bandwidths are needed, and consequently power consumption increases.

3. With use of millimeter waves and terahertz, sites are relatively densely deployed, and consequently power consumption increases.

In addition to the significant increase in the operators' costs due to the increase in the power consumption, energy saving and emission reduction are also a social responsibility for operators. Therefore, how to reduce the power consumption has become a technical problem urgently to be resolved.

In the DC scenario, the master station and the secondary station may use a same RAT or different RATs. 5G release 15 (R15) specifies that activation and deactivation of the secondary station may completely depend on an RRC signaling configuration. After the secondary station is added by using RRC signaling, the secondary station is in an activated state, and the terminal device may initiate access on the secondary station, and may perform subsequent data transmission after the terminal device completes the access; and after the secondary station is removed by using RRC signaling, the secondary station is in a deactivated state, and the terminal device may directly remove a configuration related to the secondary station.

In addition, in the DC scenario, if the secondary station changes, configuration needs to be performed on the master station by using the RRC signaling. If the master station changes, a switching command needs to be delivered to the terminal device, so that the terminal device switches a primary component carrier, and a current primary component carrier fails.

For a CA, only the primary component carrier and the secondary component carrier use a same RAT. Activation and deactivation of the CA in R15 depend on RRC signaling and a MAC CE indication. A secondary component carrier may be added or removed by using RRC signaling. In a scenario in which the secondary component carrier is added by using RRC signaling, the secondary component carrier is still in a deactivated state after being added, and an activation indication may be then performed by using a MAC CE; and correspondingly, for an activated carrier, the secondary component carrier may also be deactivated by using a MAC CE. FIG. 6 is a diagram of a MAC CE indication according to an embodiment of the disclosure. As shown in FIG. 6, the MAC CE may use one octet to activate/deactivate an SCell, or may use four octets to activate/deactivate an SCell. FIG. 6 shows that the SCell is activated/deactivated in a bitmap manner, where R represents a reserved (R) bit, remaining bits are valid bits, and each valid bit indicates activation/deactivation of a corresponding carrier. For example, when a value of a bit is “0”, deactivation is indicated, and when a value of a bit is “1”, activation is indicated.

It should be understood that FIG. 6 is an example description of the MAC CE indication, and constitutes no limitation on the MAC CE indication. For example, the MAC CE may alternatively use two or three octets to activate/deactivate an SCell. For another example, the MAC CE may use one quartet to activate/deactivate an SCell.

To further shorten secondary component carrier activation time, 5G release 16 (R16) is further enhanced based on R15, and specifies that a secondary component carrier state is directly configured by using RRC signaling. For initial addition of a secondary component carrier, restoration/addition of a secondary component carrier in an RRC recovery process, and a configuration of a target secondary component carrier in a switching process, it may all indicate by using the RRC signaling that a state of the secondary component carrier is an activated state.

In addition, in a CA scenario, if a primary component carrier changes, for example, a signal on the current primary component carrier suddenly deteriorates and a radio link failure is caused, the terminal device may switch the primary component carrier by delivering a switching command to the terminal device, and the current primary component carrier fails. If a secondary component carrier changes, configuration needs to be performed on the master station by using RRC signaling.

However, in a case in which the CA and the DC are combined, if the master station and the secondary station use different RATs, addition or removal of the secondary component carrier needs to be separately notified on the master station and the secondary station, resulting in a waste of transmission resources.

In the CA scenario, the primary component carrier changes by using the switching command, resulting in long service interruption time. When the secondary component carrier changes, the RRC reconfiguration is needed for configuration, resulting in a waste of transmission resources.

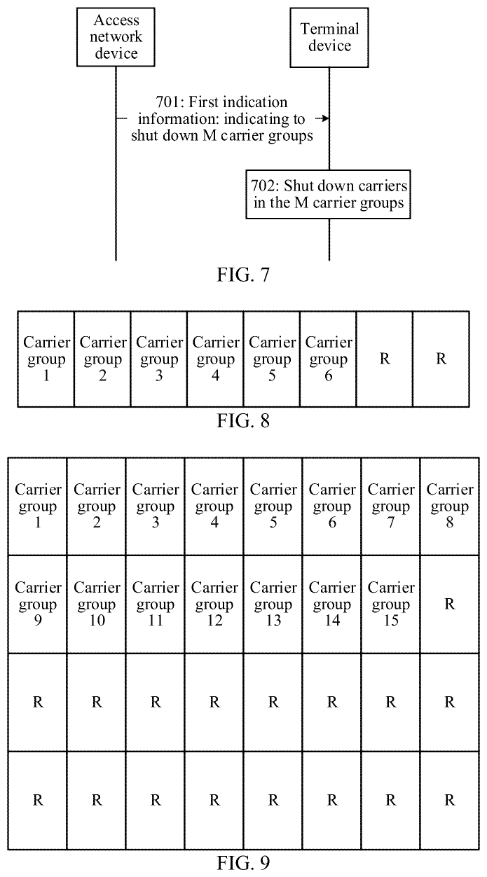

FIG. 7 is a interaction diagram of a communication method according to an embodiment of the disclosure. In the communication method, an access network device may send, to a terminal device, first indication information indicating to shut down M carrier groups, and the terminal device may shut down carriers in the M carrier groups based on the first indication information. As shown in FIG. 7, the communication method may include the following steps.

701: The access network device sends, to the terminal device, the first indication information indicating to shut down the M carrier groups.

Correspondingly, the terminal device receives, from the access network device, the first indication information indicating to shut down the M carrier groups.

The access network device may determine whether a first condition is met. When determining that the first condition is met, the access network device may determine that the carrier groups need to be shut down. The access network device may first determine the M carrier groups that need to be shut down, and may then send the first indication information to the terminal device.

After a carrier is shut down, the access network device and the terminal device do not communicate with each other by using the carrier, that is, the terminal device and the access network device do not transmit information by using the carrier. Shutting down a carrier may be understood as deactivating a carrier, or may be understood as removing a carrier, or may be understood as disabling a carrier, or may be understood as sleeping a carrier. This is not limited herein.

The access network device may determine, based on a quantity of users, a load status, and the like, whether the first condition is met. For example, the access network device may determine whether there is a carrier group in which a quantity of online users on each carrier is less than a first threshold, that is, determine whether there is a carrier group in which a quantity of online users on each carrier is less than the first threshold in all carrier groups, and when determining that a quantity of online users on each carrier in at least one carrier group is less than the first threshold, determine that the first condition is met. For another example, the access network device may determine whether there is a carrier group in which a data amount on each carrier is less than a second threshold, and when determining that a data amount on each carrier in at least one carrier group is less than the second threshold, determine that the first condition is met. For another example, the access network device may determine whether there is a carrier group in which a resource block (RB) utilization rate on each carrier is less than a third threshold, and when determining that RB utilization rate on each carrier in at least one carrier group is less than the third threshold, determine that the first condition is met. The quantity of online users can be understood as a quantity of users in a connected state on the carrier. The data amount may be understood as a sum of uplink data to be sent by a user and/or a sum of downlink data to be sent to the user.

The first indication information may indicate to shut down the M carrier groups. Each of the M carrier groups may include one carrier, or may include a plurality of carriers, and M is an integer greater than or equal to 1. It can be learned that the access network device may indicate the terminal device to shut down one carrier group, or may indicate the terminal device to shut down a plurality of carrier groups.

The following describes several manners in which the access network device sends the first indication information.

In a case, the access network device may send the first indication information to the terminal device in a multicast manner. In this case, the terminal device may be any one of terminal devices in a multicast group.

The first indication information may further include a group identifier identifying a group in which the terminal device is located, so that the terminal device in the multicast group can successfully receive the first indication information based on the group identifier, and a terminal device outside the multicast group cannot successfully receive the first indication information, to ensure information transmission reliability.

The M carrier groups may be some or all of the carrier groups configured by the access network device for all the terminal devices in the multicast group.

For example, the multicast group may include three terminal devices, and carrier groups configured by the access network device for the three terminal devices are respectively a carrier group 1, a carrier group 2, and a carrier group 3. The M carrier groups may be the carrier group 1, the carrier group 2, or the carrier group 3 in the three carrier groups, or may be the carrier group 1 and the carrier group 2, or may be the carrier group 1 and the carrier group 3, or may be the carrier group 2 and the carrier group 3, or may be the carrier group 1, the carrier group 2, and the carrier group 3.

Optionally, the access network device transmits, in the multicast manner, encryption-related information required for the first indication information, such as an encryption algorithm, a key, and a group identifier. The access network device may preconfigure the encryption-related information for each terminal device in the multicast group in a unicast manner. Before sending the first indication information to the terminal device in the multicast manner, the access network device may first configure, for each terminal device in the multicast group by using configuration information, multicast-related information, for example, the encryption-related information. For example, the access network device may configure the multicast-related information by using an RRC reconfiguration message.

In another case, the access network device may send the first indication information to the terminal device in a broadcast manner. Correspondingly, the terminal device may receive the first indication information from the access network device in the broadcast manner. In this case, provided that all terminal device within coverage of the access network device can successfully receive the first indication information, the foregoing terminal device may be any terminal device within the coverage of the access network device.

The M carrier groups may be some or all of the carrier groups configured by the access network device for the terminal devices within the coverage of the access network device.

In still another case, the access network device may send the first indication information to the terminal device in a unicast manner.

The M carrier groups may be some or all of the carrier groups configured by the access network device for the terminal device.

When the access network device needs to send, to a plurality of terminal devices, the indication information indicating to shut down the carrier groups, to reduce an amount of transmitted information or signaling, the access network device may send the first indication information to the terminal devices in a multicast manner or a broadcast manner. To reduce the amount of transmitted signaling, when carriers belonging to the M carrier groups are configured for two or more terminal devices, the access network device may send the first indication information to the terminal devices in the multicast manner or the broadcast manner.

To reduce the amount of transmitted signaling, when carriers in the M carrier groups are configured for all terminal devices within coverage of the access network device, the access network device may send the first indication information to the terminal devices in the broadcast manner. Alternatively, the first indication information may be transmitted in the multicast manner. In this case, there may be a plurality of multicast groups, so that all the terminal devices can be covered.

When carriers in the M carrier groups are configured for some terminal devices within the coverage of the access network device, the first indication information may be transmitted in the multicast manner, to keep the terminal device from receiving unnecessary information to reduce power consumption of the terminal device. In this case, the multicast group may include only these terminal devices.

When the access network device needs to send, to a terminal device, indication information indicating to shut down a carrier group, the access network device may send the first indication information to the terminal device in a unicast manner.

It should be understood that when the access network device needs to send the first indication information to the plurality of terminal devices in the unicast manner, the access network device may separately send the first indication information to the plurality of terminal devices in the unicast manner.

It should be understood that carriers configured by the access network device for a same terminal device may belong to a same carrier group, or may belong to different carrier groups. The access network device may configure some or all carriers in the same carrier group for one terminal device, or may configure some or all carriers in different carrier groups for the same terminal device. For example, it is assumed that the carrier group 1 includes a carrier 1, a carrier 2, and a carrier 3, and the carrier group 2 includes a carrier 4 and a carrier 5. The access network device may configure the carrier 4 and/or the carrier 5 for one terminal device, or may configure one or more of the carrier 1, the carrier 2, and the carrier 3, and the carrier 4 and/or the carrier 5 for one terminal device.

The M carrier groups may be all being used, or may be all not being used; or some carrier groups may be being used, or some carrier groups may be not being used.

That a carrier group is being used may be understood as that a carrier in carriers belonging to the carrier group is being used. That a carrier group is not being used may be understood as that no carrier is being used in carriers belonging to the carrier group. That a carrier is being used may be understood as that the carrier is activated but currently does not transmit information, or may be understood as that the carrier is activated and is being used to transmit information. That a carrier is not being used may be understood as that the carrier is not activated, or may be understood as that the carrier is activated but currently does not transmit information.

A carrier included in each of the M carrier groups may be associated with one RAT, or may be associated with a plurality of RATs. When each carrier group is associated with one RAT, the M carrier groups may be associated with one RAT, or may be associated with a plurality of RATs.

For example, it is assumed that a carrier group includes a carrier 1, a carrier 2, and a carrier

3. When the carrier 1, the carrier 2, and the carrier 3 are all NR carriers or 6G carriers, the carriers included in the carrier group are associated with one RAT, namely, NR or 6G. When the carrier 1 is an NR carrier, and the carrier 2 and the carrier 3 are 6G carriers, the carriers included in the carrier group are associated with two RATs, namely, NR and 6G.

When the access network device sends the first indication information to the terminal device in the unicast manner, if the M carrier groups are associated with a plurality of RATs, the access network device may send the first indication information to the terminal device by using one of carriers corresponding to each of the plurality of RATs. In other words, when the M carrier groups are associated with a specific quantity of RATs, the access network device sends the first indication information to the terminal device for the quantity of times, and carriers corresponding to different RATs are used each time the first indication information is sent. It can be learned that when configuring a plurality of carriers in a RAT for the terminal device, the access network device needs to send the first indication information to the terminal device only once by using one of the carriers, and does not need to separately send the first indication information to the terminal device on each carrier. This can reduce an amount of sent first indication information, that is, reduce an amount of transmitted signaling, thereby saving transmission resources.

For example, assuming that a carrier group includes a carrier 1, a carrier 2, a carrier 3, and a carrier 4, the carrier 1 and the carrier 4 are NR carriers, and the carrier 2 and the carrier 3 are 6G carriers, the access network device may send the first indication information to the terminal device by using one carrier, namely, the carrier 1 or the carrier 4 in NR, and may send the first indication information to the terminal device by using one carrier, namely, the carrier 2 or the carrier 3 in 6G.

When the M carrier groups are associated with the plurality of RATs, the access network device may alternatively send the first indication information to the terminal device only once by using a primary component carrier or a secondary component carrier in one of the plurality of RATs. It can be learned that, regardless of a quantity of RATs corresponding to the M carrier groups, the first indication information may be sent only once for the M carrier groups, so that a quantity of times of sending the first indication information can be reduced, thereby saving transmission resources. That is, the indication information used to shut down the M carrier groups may not distinguish between the RATs.

At least one carrier group in the M carrier groups may include a plurality of carriers, so that a quantity of transmitted signaling can be reduced, thereby saving transmission resources. In addition, in a case in which one carrier group includes a plurality of carriers, and one piece of first indication information is needed to indicate to shut down the plurality of carriers, when the carrier is used as a granularity, the first indication information needs to indicate to disable the plurality of carriers simultaneously, and the first indication information needs more indication information. However, when the carrier group is used as a granularity, the first indication information needs to indicate to disable only the carrier group, and the first indication information needs little indication information, so that an amount of information that needs to be indicated in the first indication information can be reduced, thereby improving resource utilization.

For example, a carrier group 1 includes a carrier 1, a carrier 2, and a carrier 3. When a carrier is used as a granularity, the first indication information needs to indicate to disable the carrier 1, the carrier 2, and the carrier 3, and three pieces of information are needed for indication. When the carrier group is used as a granularity, the first indication information indicates to disable the carrier group 1, and only one piece of information is needed for indication.

In an implementation, the access network device may further send the second indication information to the terminal device. Correspondingly, the terminal device may receive the second indication information from the access network device. The second indication information indicates a total quantity of carrier groups, namely, a total quantity of carrier groups on the access network device. The total quantity of carrier groups may be greater than M, or may be equal to M.

When the total quantity of carrier groups on the access network device remains unchanged, the access network device may send the second indication information to the terminal device when each terminal device performs access. When each terminal device performs access, the access network device needs to send the second indication information to the terminal device only once, and does not need to repeatedly send the second indication information.

When the total quantity of carrier groups on the access network device changes, the access network device may send the second indication information to the terminal device when each terminal device performs access. Alternatively, the access network device may send the second indication information to the terminal device when the total quantity of carrier groups changes.

The access network device may send the second indication information to the terminal device within the coverage of the access network device in the broadcast manner, or may send the second indication information to the terminal device in the multicast manner, or may send the second indication information to the terminal device in the unicast manner.

In a case, the first indication information may be a bitmap, and the bitmap includes at least K bits. K is a quantity of all carrier groups on the access network device, namely, the total quantity of carrier groups. The K bits are in one-to-one correspondence with K carrier groups. Each of the K bits indicates whether to shut down a corresponding carrier group.

In an implementation, a protocol may specify a quantity of bits included in the bitmap, that is, a length of the bitmap is fixed. However, the access network device may determine valid bits in the bitmap based on a total quantity of carrier groups, and remaining bits may be reserved (R) bits.

In this case, the terminal device may determine the total quantity of carrier groups based on the second indication information sent by the access network device, to determine valid bits in the bitmap.

In one manner, a correspondence between a bit in a bitmap and a carrier group may be defined, specified, or predefined in a protocol. For example, the protocol may specify that an ith bit indicates whether to shut down an ith carrier group. For another example, the protocol may specify that an ith bit indicates whether to shut down a (K-i+1)^{th} carrier group. In this case, the access network device does not need to indicate a correspondence between each valid bit and a carrier group to the terminal device.

In another manner, the access network device may indicate a correspondence between each valid bit and a carrier group. In a manner, the access network device may preconfigure a correspondence between each bit in a bitmap and a corresponding carrier group for the terminal device. In another manner, the first indication information may include a correspondence between each bit in a bitmap and a corresponding carrier group. The correspondence between each bit in the bitmap and the corresponding carrier group may be shown in Table 1.

TABLE 1

| Identifiers of bits | Identifiers of carrier groups |
|---|---|
| 1 | Carrier group 1 |
| 2 | Carrier group 2 |
| . . . | . . . |
| K | Carrier group K |

It should be understood that Table 1 is an example description of the correspondence between each bit in the bitmap and the corresponding carrier group, and constitutes no limitation thereto.

In an implementation, it may be predefined that the length of the bitmap is one byte, that is, the length of the bitmap is eight bits. In this case, the bitmap can indicate a maximum of eight carrier groups. When the total quantity of carrier groups is less than 8, the carrier groups may be supplemented by using a reserved bit. FIG. 8 is a diagram of a bitmap according to an embodiment of the disclosure. As shown in FIG. 8, a total quantity of carrier groups is 6. Therefore, there are six valid bits in the bitmap, and remaining two bits are reserved bits. For example, when a value of a bit is 1, it may indicate to shut down a corresponding carrier group; and when a value of a bit is 0, it may indicate not to shut down a corresponding carrier group. For another example, when a value of a bit is 0, it may indicate to shut down a corresponding carrier group; and when a value of a bit is 1, it may indicate not to shut down a corresponding carrier group. For another example, when a value of a bit is 1, it may indicate to shut down a corresponding carrier group; and when a value of a bit is 0, it may indicate to enable a corresponding carrier group. i=1, 2, . . . , K.

In another implementation, it may be predefined that the length of the bitmap is four bytes, that is, the length of the bitmap is 32 bits. In this case, the bitmap can indicate a maximum of 32 carrier groups. FIG. 9 is a diagram of another bitmap according to an embodiment of the disclosure. As shown in FIG. 9, a total quantity of carrier groups is 15. Therefore, there are 15 valid bits in the bitmap, and remaining 17 bits are reserved bits.

It should be understood that FIG. 8 and FIG. 9 are example descriptions of the bitmaps, and constitute no limitation thereto. For example, the length of the bitmap may alternatively be two bytes, three bytes, or the like. For example, valid bits in FIG. 8 may be last six bits.

In another implementation, a quantity of bits included in the bitmap is not fixed. The access network device may determine, based on the total quantity of carrier groups, the quantity of bits included in the bitmap (namely, the length of the bitmap). That is, the quantity of bits included in the bitmap may be equal to the total quantity of carrier groups (that is, K).

In this case, the length of the bitmap is the total quantity of carrier groups. Identifiers of the 1^{st} carrier group, the 2^{nd} carrier group, . . . , and a K^{th} carrier group may be in ascending order or in descending order.

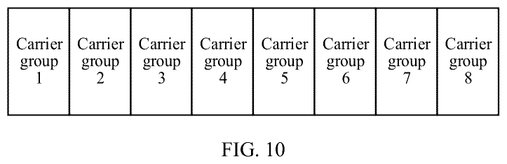

For example, FIG. 10 is a diagram of still another bitmap according to an embodiment of the disclosure. As shown in FIG. 10, a total quantity of carrier groups is 8, a bitmap includes eight bits, and the eight bits are in one-to-one correspondence with identifiers of the eight carrier groups.

It should be understood that FIG. 10 is an example description of the bitmap, and constitutes no limitation thereto. For example, an i^{th} bit indicates whether to shut down a (K-i+1)^{th} carrier group.

When the first indication information is a bitmap, provided that a carrier group in all carrier groups needs to be shut down, the access network device may send the first indication information to the terminal device in the multicast manner, the broadcast manner, or the unicast manner by using carriers corresponding to all the carrier groups, or may send the first indication information to the terminal device in the multicast manner, the broadcast manner, or the unicast manner only by using carriers corresponding to the carrier group that needs to be shut down. The carriers corresponding to the carrier group may be understood as all or some carriers in the carrier group.

In another case, the first indication information may include a shutdown indication and/or identifiers of M carrier groups. Optionally, the first indication information may include a shutdown indication and an identifier of a carrier group that needs to be shut down.

In this case, because the terminal device needs to determine, based on the total quantity of carrier groups, bits needed by an identifier of a carrier group, the access network device needs to send second indication information to the terminal device.

If a carrier group in all the carrier groups needs to be shut down, the access network device may send the first indication information to the terminal device in the multicast manner or the broadcast manner by using one or more carriers.

In an implementation, a length of the first indication information is variable. The access network device may determine the length of the first indication information based on the identifiers and a quantity of carrier groups that need to be shut down.

When the first indication information includes the shutdown indication, a bit needed (or occupied) by the shutdown indication may be predefined. For example, the shutdown indication may be performed by using one bit. For example, when “1” indicates shutdown, a value of this bit in the first indication information is 1. For another example, when “0” indicates shutdown, a value of this bit in the first indication information is 0. The shutdown indication may alternatively be performed by using two bits. For example, when “11” indicates shutdown, a value of this bit in the first indication information is 1. For another example, when “00” indicates shutdown, a value of this bit in the first indication information is 0. The shutdown indication may alternatively be performed by using other bits.

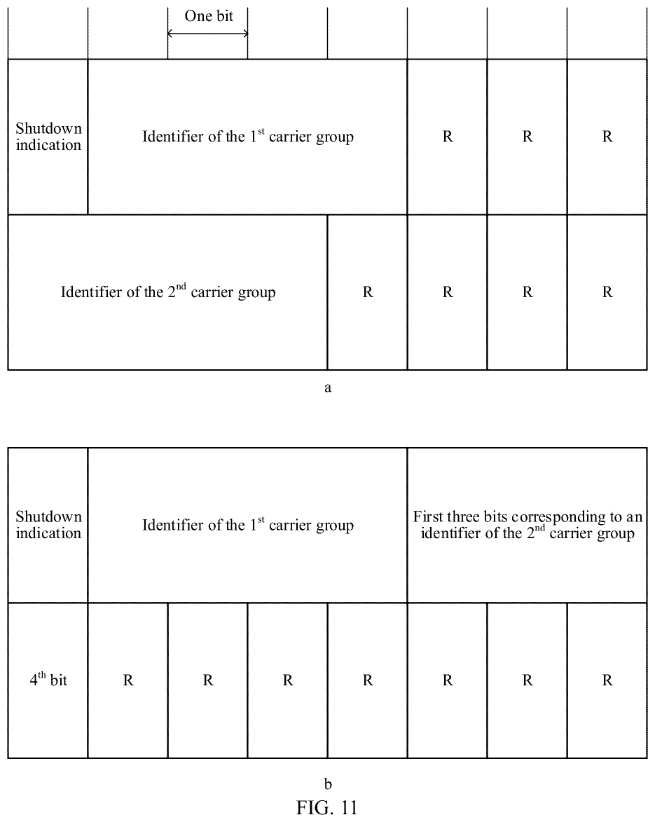

For example, when the total quantity of carrier groups is 10, the quantity of bits occupied by the shutdown indication is 1, and indication is performed in a unit of byte, an identifier of each carrier group occupies four bits. If two carrier groups need to be shut down, the first indication information needs nine bits, and the first indication information may use two bytes. FIG. 11 is a diagram of a type of first indication information according to an embodiment of the disclosure. As shown in a in FIG. 11, the 1^{st} byte includes a shutdown indication and an identifier of the 1^{st} carrier group, and remaining three bits are reserved bits; and the 2^{nd} byte includes an identifier of the 2^{nd} carrier group, and remaining four bits are reserved bits. As shown in b in FIG. 11, the 1^{st} byte includes a shutdown indication, an identifier of the 1^{st} carrier group, and first three bits of an identifier of the 2^{nd} carrier group; and the 2^{nd} byte includes the 4^{th} bit of the identifier of the 2^{nd} carrier group, and remaining seven bits are reserved bits.

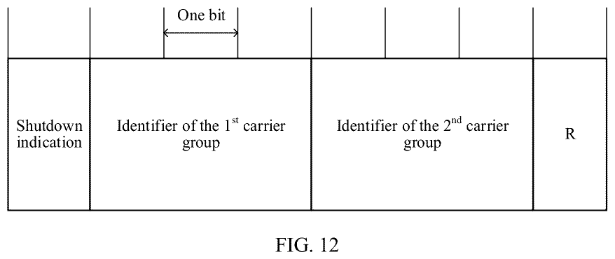

For another example, when a total quantity of carrier groups is 6, and the shutdown indication occupies one bit, an identifier of each carrier group needs to be indicated by using three bits. If two carrier groups need to be shut down, the first indication information needs seven bits, and the first indication information may use one byte. FIG. 12 is a diagram of another type of first indication information according to an embodiment of the disclosure. As shown in FIG. 12, this byte includes a shutdown indication, an identifier of the 1^{st} carrier group, and an identifier of the 2^{nd} carrier group, and remaining one bit is a reserved bit.

A length of first indication information may alternatively be fixed. The length of the first indication information has been predefined, but valid bits in the first indication information may be determined based on identifiers and a quantity of carrier groups that need to be shut down. For example, the predefined length is two bytes. When a total quantity of carrier groups is 10, an identifier of each carrier group needs to be indicated by using four bits. If two carrier groups need to be shut down, the first indication information needs 10 bits, and remaining six bits are reserved bits. For another example, when a total quantity of carrier groups is 6, an identifier of each carrier group needs to be indicated by using three bits. If two carrier groups need to be shut down, the first indication information needs eight bits, and remaining 10 bits are reserved bits.

That the first indication information includes the shutdown indication is described above, and a case in which the first indication information does not include the shutdown indication is similar. Details are not described herein again.

The first indication information may implicitly indicate the shutdown indication.

In a case, when the first indication information is transmitted by using a specific time-frequency resource, the first indication information may indicate the shutdown indication. In other words, there is a correspondence between the shutdown indication and the time-frequency resource.

In this case, because the terminal device needs to determine, based on the total quantity of carrier groups, bits needed by an identifier of a carrier group, the access network device needs to send second indication information to the terminal device.

In another case, the first indication information may include a flag bit and identifiers of M carrier groups. When the first indication information includes the flag bit, the first indication information may include the shutdown indication.

The first indication information may be carried in a system message. The access network device may send the system message to the terminal device, and the system message may include the first indication information. The system message may be a system information block (SIB). For example, the system message may be a SIB1, a SIB2, a SIB3, or another SIB. The system message is transmitted in a broadcast manner. Therefore, when the first indication information is carried in the system message, the first indication information is transmitted in the broadcast manner.

The first indication information may alternatively be carried in RRC signaling. The access network device may send the RRC signaling to the terminal device, and the RRC signaling may include the first indication information. The RRC signaling may be transmitted in a broadcast manner. Therefore, when the first indication information is carried in the RRC signaling, the first indication information may be transmitted in the broadcast manner. The RRC signaling may alternatively be transmitted in a multicast manner. Therefore, when the first indication information is carried in the RRC signaling, the first indication information may alternatively be transmitted in the multicast manner. The RRC signaling may alternatively be transmitted in a unicast manner. Therefore, when the first indication information is carried in the RRC signaling, the first indication information may alternatively be transmitted in the unicast manner.

The first indication information may alternatively be carried in a MAC CE. The access network device may send the MAC CE to the terminal device, and the MAC CE may include the first indication information. The MAC CE may be transmitted in a broadcast manner. Therefore, when the first indication information is carried in the MAC CE, the first indication information may be transmitted in the broadcast manner. The MAC CE may alternatively be transmitted in a multicast manner. Therefore, when the first indication information is carried in the MAC CE, the first indication information may alternatively be transmitted in the multicast manner. The MAC CE may alternatively be transmitted in a unicast manner. Therefore, when the first indication information is carried in the MAC CE, the first indication information may alternatively be transmitted in the unicast manner.

When the first indication information is carried in the MAC CE, the access network device may indicate a length of the MAC CE by using a MAC subheader, so that the terminal device can determine the length of the MAC CE based on the MAC subheader, and further receive the MAC CE.

Different MAC CEs have different corresponding LCIDs, and the MAC subheaders include the LCIDs used to distinguish between the different MAC CEs. Therefore, the MAC CE may correspond to a predefined LCID.

The first indication information may alternatively be carried in DCI. The access network device may send the DCI to the terminal device, and the DCI may include the first indication information. The DCI may be transmitted in a broadcast manner. Therefore, when the first indication information is carried in the DCI, the first indication information may be transmitted in the broadcast manner. The DCI may alternatively be transmitted in a multicast manner. Therefore, when the first indication information is carried in the DCI, the first indication information may alternatively be transmitted in the multicast manner. The DCI may alternatively be transmitted in a unicast manner. Therefore, when the first indication information is carried in the DCI, the first indication information may alternatively be transmitted in the unicast manner.

The DCI may be DCI specially indicating to shut down the M carrier groups, namely, DCI specially used to transmit the first indication information, or may reuse another DCI. When the another DCI is reused to indicate to shut down the M carrier groups, a related field may be added to original DCI to carry the first indication information. When the reused DCI is sent in the unicast manner, the DCI needs to be separately sent to different terminal devices.

Carriers in a same carrier group may belong to a same PA, that is, carriers may be grouped into a carrier group based on a granularity of a PA, that is, carriers belonging to a same PA may be classified into one carrier group (namely, a PA group).

Carriers in a same carrier group may alternatively belong to a same bandwidth, that is, carriers may be grouped into a carrier group based on a granularity of a bandwidth, that is, carriers belonging to a same bandwidth may be classified into one carrier group (namely, a bandwidth group). Operating bandwidths in NR may be shown in Table 2.

TABLE 2

| NR operating | Uplink operating | Downlink operating |
|---|---|---|
| bandwidths | bandwidths | bandwidths |
| n1 | 1920-1980 MHz | 2110-2170 MHz |
| n2 | 1850-1910 MHz | 1930-1990 MHz |
| n3 | 1710-1785 MHz | 1805-1880 MHz |
| n5 | 824-849 MHz | 869-894 MHz |
| n7 | 2500-2570 MHz | 2620-2690 MHz |
| n8 | 880-915 MHz | 925-960 MHz |
| n12 | 699-716 MHz | 729-746 MHz |
| n14 | 788-798 MHz | 758-768 MHz |

Operating bandwidths in LTE may be shown in Table 3.

TABLE 3

| Operating | Uplink operating | Downlink operating |
|---|---|---|
| bandwidth | bandwidths | bandwidths |
| 1 | 1920-1980 MHz | 2110-2170 MHz |
| 2 | 1850-1910 MHz | 1930-1990 MHz |
| 3 | 1710-1785 MHz | 1805-1880 MHz |
| 4 | 1710-1755 MHz | 2110-2155 MHz |
| 5 | 824-849 MHz | 869-894 MHz |
| 6 | 830-840 MHz | 875-885 MHz |
| 7 | 2500-2570 MHz | 2620-2690 MHz |
| 8 | 880-915 MHz | 925-960 MHz |
| 9 | 1749.9-1784.9 MHz | 1844.9-1879.9 MHz |
| 10 | 1710-1770 MHz | 2110-2170 MHz |
| 11 | 1427.9-1447.9 MHz | 1475.9-1495.9 MHz |
| 12 | 699-716 MHz | 729-746 MHz |
| 13 | 777-787 MHz | 746-756 MHz |
| 14 | 788-798 MHz | 758-768 MHz |

It should be understood that Table 2 shows a part of the NR operating bandwidths defined in a protocol, and Table 3 shows a part of the LTE operating bandwidths defined in the protocol. It can be learned from Table 2 and Table 3 that, same bands (or bandwidths) in different standards have a same number. For example, n8 in Table 2 and 8 in Table 3 correspond to uplink 880 MHZ-915 MHz and downlink 925 MHz-960 MHz. Therefore, numbers of the bandwidths in any standards are both 8.

It should be understood that the carriers may alternatively be grouped into a carrier group based on another granularity. For example, division may be performed based on another frequency domain unit.

When a carrier group corresponding to each carrier is specified in the protocol, the terminal device may determine the carrier group corresponding to each carrier. Therefore, the access network device does not need to indicate, to the terminal device, the carrier group corresponding to each carrier. For example, when the carriers are grouped into the carrier group based on the bandwidth, because a bandwidth corresponding to each carrier has been specified in the protocol, the access network device does not need to indicate, to the terminal device, the bandwidth corresponding to each carrier.

When the carrier group corresponding to each carrier is specified in the protocol, the access network device needs to indicate, to the terminal device, the carrier group corresponding to each carrier. Therefore, the access network device may further send third indication information to the terminal device. Correspondingly, the terminal device receives the third indication information from the access network device. The third indication information may indicate a carrier group corresponding to a first carrier. The first carrier may be any one of all carriers on the access network device.

For example, when the carriers are grouped into the carrier group based on the PA, because a PA corresponding to each carrier is not specified in the protocol, the access network device may send the third indication information to the terminal device. Correspondingly, the terminal device receives the third indication information from the access network device. The third indication information may indicate a PA corresponding to the first carrier.

The third indication information may include an identifier of the carrier group corresponding to the first carrier.

When the third indication information is sent to the terminal device by using the first carrier, the third indication information may include only the identifier of the carrier group corresponding to the first carrier.

The third indication information may further include an identifier of the first carrier. For example, the third indication information may be a carrier 1 and a carrier group 1.

The third indication information may be carried in a system message, RRC signaling, a MAC CE, or DCI. For detailed descriptions, refer to the foregoing related information of the first indication information.

The access network device may send the third indication information to the terminal device in the broadcast manner. For example, because the SIBI needs to be broadcast on each carrier, the access network device may send the third indication information to the terminal device by using the SIBI corresponding to the first carrier. The access network device may alternatively send the third indication information to the terminal device in the multicast manner. The access network device may alternatively send the third indication information to the terminal device in the unicast manner.

The access network device may alternatively send the third indication information to the terminal device in the broadcast manner and the unicast manner. For example, for a terminal device using CA, the access network device may indicate, to the terminal device by using a system message corresponding to a primary component carrier, a carrier group corresponding to the primary component carrier, and may indicate, by using RRC signaling, a MAC CE, or DCI used to add a secondary component carrier, a carrier group corresponding to the secondary component carrier.

The access network device may send the third indication information to the terminal device when configuring the first carrier, or may send the third indication information to the terminal device after configuring the first carrier.

The access network device may further send configuration information to the terminal device. Correspondingly, the terminal device may receive the configuration information from the access network device. The configuration information may be used to configure a candidate primary component carrier. The candidate primary component carrier may be used for a master station or a secondary station.

The access network device may configure a candidate primary component carrier for each terminal device. The candidate primary component carrier may be used for the master station or the secondary station. Which one is first needed may first use the candidate primary component carrier.

The access network device may alternatively configure two candidate primary component carriers for each terminal device, where one candidate primary component carrier is used for the master station, and the other candidate primary component carrier is used for the secondary station. For example, the access network device may configure a candidate PCell, namely, a candidate master station primary component carrier, and configure a candidate PSCell, namely, a candidate secondary station primary component carrier.

The configuration information may include related configurations for activating the candidate primary component carrier, such as a physical downlink control channel (PDCCH) configuration and a physical uplink control channel (PUCCH) configuration.

702: The terminal device shuts down carriers in the M carrier groups.

After receiving the first indication information from the access network device, the terminal device may shut down the carriers in the M carrier groups, that is, may shut down the carriers in the M carrier groups based on the first indication information.

When the first carrier group includes a plurality of carriers, for different terminal devices, the plurality of carriers may be primary component carriers corresponding to different RATs, or may be secondary component carriers corresponding to different RATs, or may be primary component carriers and secondary component carriers corresponding to different RATs. The terminal device may shut down, based on the first indication information, the carriers included in the first carrier group. That is, regardless of which RAT to which the carrier included in the first carrier group belongs, whether the carrier belongs to the master station or the secondary station, or whether the carrier is the primary component carrier or the secondary component carrier, the terminal device shuts down the carrier included in the first carrier group. It can be learned that the indication information used to shut down the M carrier groups may not distinguish between the CA and DC. The first carrier group is any one of the M carrier groups.

When a second carrier is a master station primary component carrier, after the second carrier is shut down, the candidate primary component carrier or the candidate master station primary component carrier configured by using the configuration information may be activated as a primary component carrier, so that switching performed by using the signaling can be avoided, thereby shortening service interruption time and improving user experience. The second carrier is any carrier included in the M carrier groups.

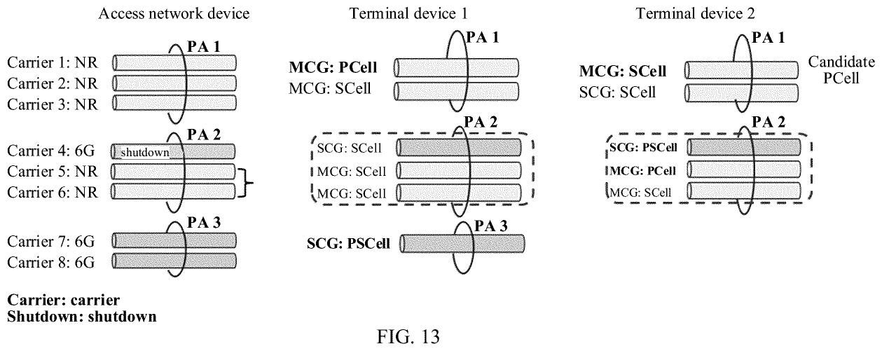

FIG. 13 is a diagram of dividing carrier groups based on PAs according to an embodiment of the disclosure. As shown in FIG. 13, an access network device includes three PA groups: a PA 1, a PA 2, and a PA 3. Three carriers in the PA 1 correspond to NR, three carriers in the PA 2 correspond to 6G and NR, and two carriers in the PA 3 correspond to 6G.

A plurality of carriers, namely, an MCG PCell and two MCG SCells, and an SCG PSCell and one SCG SCell, are configured for both a master station and a secondary station corresponding to a terminal device 2. When adding a secondary component carrier on the MCG, the access network device configures an MCG SCell in the PA 1 as a candidate primary component carrier, namely, the MCG SCell in bold in the PA 1 in the figure. It is assumed that the access network device indicates to shut down the PA 2. Because an MCG PCell is included in the PA 2, after receiving indication information indicating to shut down the PA 2, the terminal device 2 may activate a candidate carrier as a primary component carrier immediately or after predefined time, and the MCG SCell under the PA 1 takes effect as an MCG PCell. Because the PA 2 is shut down, the terminal device 2 does not have another carrier on the MCG. Consequently, in this case, the terminal device 2 has only one carrier on the MCG. If there is another SCell on the MCG, there are still a plurality of carriers on the MCG, that is, the SCell continues to take effect.

When a second carrier is a secondary station primary component carrier, after the second carrier is shut down, a candidate primary component carrier or a candidate secondary station primary component carrier configured by using configuration information may be activated as a secondary station primary component carrier, so that a change by using signaling can be avoided, a change of the secondary station primary component carrier can be implemented more quickly, and transmitted signaling can be reduced, thereby saving transmission resources.

The terminal device 2 in FIG. 13 is used as an example for description. The access network device may configure the SCG SCell under the PA 1 as a candidate secondary station primary component carrier. After the PA 2 is shut down, the terminal device 2 may activate the SCG SCell in the PA 1 as an SCG PSCell.

As shown in a terminal device 1 in FIG. 13, first indication information indicates to shut down the PA 2. For the terminal device 1, the PA 2 includes both a master station secondary component carrier and a secondary station secondary component carrier. The access network device may send the first indication information only by using a carrier. After receiving the first indication information, the terminal device 1 may shut down the three carriers in the PA 2.

After shutting down carriers in M carrier groups, the terminal device may send or not send feedback information to the access network device.

When the first indication information is carried in a system message and DCI, the terminal device does not send the feedback information to the access network device after shutting down the carriers in the M carrier groups. After the access network device sends the first indication information to the terminal device, the terminal device may immediately disable the carriers in the M carrier groups, or may wait for a period of time and then disable the carriers in the M carrier groups.

When the first indication information is carried in RRC signaling such as an RRC reconfiguration message, after shutting down the carriers in the M carrier groups, the terminal device may send an RRC reconfiguration complete message to the access network device. After receiving the RRC reconfiguration complete message from the terminal device, the access network device may disable the carriers in the M carrier groups.

When the first indication information is carried in a MAC CE, after shutting down the carriers in the M carrier groups, the terminal device may send acknowledge (ACK) information to the access network device by using a hybrid automatic repeat request (HARQ). After receiving the ACK information from the terminal device, the access network device may disable the carriers in the M carrier groups.

After the M carrier groups are shut down, the access network device may send fourth indication information to the terminal device when determining that a second condition is met. Correspondingly, the terminal device receives the fourth indication information from the access network device. The fourth indication information indicates to enable N carrier groups, and N is an integer greater than or equal to 1.

The terminal device may enable carriers corresponding to the N carrier groups. Similarly, after enabling the carriers corresponding to the N carrier groups, the terminal device may send or not send feedback information to the access network device.

After the carriers corresponding to the N carrier groups are enabled, the access network device may configure the terminal device on the enabled carriers in a reconfiguration manner; or may increase priorities of the enabled carriers, so that the terminal device can preferentially use the enabled carriers.

For detailed descriptions of the fourth indication information, refer to the first indication information. A difference lies in that one indicates to shut down a carrier group, and the other indicates to enable a carrier group.

The access network device may determine, based on information such as a quantity of users and a load status on an activated carrier, whether the second condition is met. For example, the access network device may determine whether there is a carrier group in which a quantity of online users on each carrier is greater than or equal to a first threshold, and when determining that a quantity of online users on each carrier in at least one carrier group is greater than or equal to the first threshold, determine that the second condition is met. For another example, the access network device may determine whether there is a carrier group in which a data amount on each carrier is greater than or equal to a second threshold, and when determining that a data amount on each carrier in at least one carrier group is greater than or equal to the second threshold, determine that the second condition is met. For another example, the access network device may determine whether there is a carrier group in which an RB utilization rate on each carrier is greater than or equal to a third threshold, and when determining that an RB utilization rate on each carrier in at least one carrier group is greater than or equal to the third threshold, determine that the second condition is met.

It should be understood that the foregoing different steps or different cases, examples, and implementations in a same step may be separately performed, or may be performed in combination with each other.

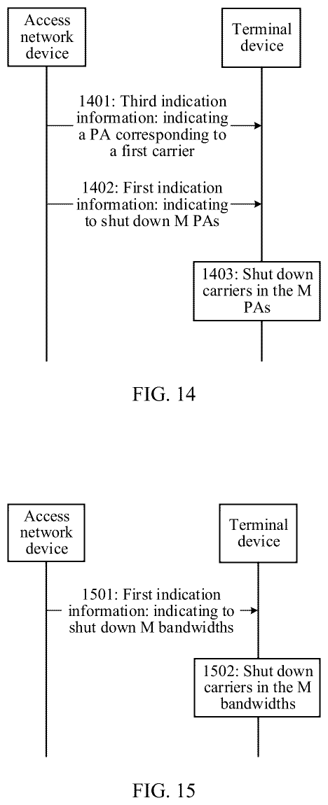

Based on the foregoing network architecture, FIG. 14 is a interaction diagram of another communication method according to an embodiment of the disclosure. As shown in FIG. 14, the communication method may include the following steps.

1401: An access network device sends, to a terminal device, third indication information indicating a PA corresponding to a first carrier.

Correspondingly, the terminal device receives, from the access network device, the third indication information indicating the PA corresponding to the first carrier.

The third indication information includes an identifier of the PA corresponding to the first carrier. The identifier of the PA may be an index of the PA, or may be another information that can uniquely identify the PA.

1402: The access network device sends, to the terminal device, first indication information indicating to shut down M PAs.

Correspondingly, the terminal device receives, from the access network device, the first indication information indicating to shut down the M PAs.

1403: The terminal device shuts down carriers in the M PAS.

After receiving the first indication information from the access network device, the terminal device may shut down the carriers in the M PAs, that is, may shut down the carriers in the M PAs based on the first indication information, and may further shut down the M PAs. Due to high power consumption of the PAs, power consumption can be greatly reduced when the carriers in the PAs and the PAs are shut down.

For detailed descriptions of step 1401 to step 1403, refer to related descriptions corresponding to FIG. 7.

Based on the foregoing network architecture, FIG. 15 is a interaction diagram of still another communication method according to an embodiment of the disclosure. As shown in FIG. 15, the communication method may include the following steps.

1501: An access network device sends, to a terminal device, first indication information indicating to shut down M bandwidths.

Correspondingly, the terminal device receives, from the access network device, the first indication information indicating to shut down the M bandwidths.

1502: The terminal device shuts down carriers in the M bandwidths.

After receiving the first indication information from the access network device, the terminal device may shut down the carriers in the M bandwidths, that is, may shut down the carriers in the M bandwidths based on the first indication information.

Carriers belonging to a same bandwidth may belong to a same PA, or may not belong to a same PA.

When a plurality of carriers configured by the access network device for the terminal device belong to the M bandwidths, and the plurality of bandwidths belong to one PA, the terminal device may further shut down the PA. Due to high power consumption of the PA, power consumption can be greatly reduced when the carriers in the bandwidths and the PA are shut down.

For example, as shown in FIG. 11, the M bandwidths include a bandwidth 1 and a bandwidth 2, the bandwidth 1 includes two NR carriers in a PA 2, and the bandwidth 2 includes one 6G carrier in the PA 2. After receiving the first indication information, a terminal device 1 and/or a terminal device 2 may shut down the two NR carriers and the 6G carrier. In addition, because the PA 2 includes only three carriers, and all the three carriers are shut down, the terminal device 1 and/or the terminal device 2 may further shut down the PA 2, so that power consumption can be further reduced.

For detailed descriptions of step 1501 and step 1502, refer to related descriptions corresponding to FIG. 7.

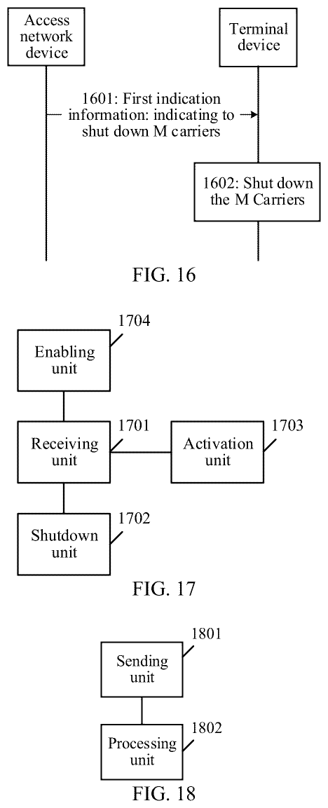

Based on the foregoing network architecture, FIG. 16 is a interaction diagram of yet another communication method according to an embodiment of the disclosure. As shown in FIG. 16, the communication method may include the following steps.

1601: An access network device sends, to a terminal device, first indication information indicating to shut down M carriers.

Correspondingly, the terminal device receives, from the access network device, the first indication information indicating to shut down the M carriers.

The M carriers may be associated with one RAT, or may be associated with a plurality of RATs, and M is an integer greater than or equal to 1. For detailed descriptions, refer to related descriptions in step 701.

The access network device sends second indication information to the terminal device. Correspondingly, the terminal device receives the second indication information from the access network device. The second indication information indicates a total quantity of carriers, and the total quantity is greater than or equal to M. For detailed descriptions, refer to related descriptions in step 701.

The access network device sends configuration information to the terminal device. Correspondingly, the terminal device receives the configuration information from the access network device. The configuration information is used to configure a candidate primary component carrier. The candidate primary component carrier is used for a master station or a secondary station. For detailed descriptions, refer to related descriptions in step 701.

The first indication information includes identifiers of the M carriers. For detailed descriptions, refer to related descriptions in step 701.

The identifiers of the carriers may be numbers obtained after the access network device uniformly numbers all carriers. All the carriers may include carriers in different RATs, or may include carriers in a same RAT.

For example, there are eight carriers in total on the access network device, and the access network device may uniformly number the eight carriers as 1 to 8.

The first indication information is carried in a system message, RRC signaling, a MAC CE, or DCI. The MAC CE corresponds to a predefined LCID. For detailed descriptions, refer to related descriptions in step 701.

The access network device sends the first indication information in a multicast manner or a broadcast manner. Correspondingly, the terminal device receives the first indication information from the access network device in the multicast or broadcast manner. The access network device sends the first indication information in a unicast manner. Correspondingly, the terminal device receives the first indication information from the access network device in the unicast manner. For detailed descriptions, refer to related descriptions in step 701.

The access network device sends third indication information to the terminal device. Correspondingly, the terminal device receives the third indication information from the access network device. The third indication information indicates to enable N carriers, and N is an integer greater than or equal to 1. For detailed descriptions, refer to the third indication information in step 701.

1602: The terminal device shuts down the M carriers.

After receiving the first indication information from the access network device, the terminal device may shut down the M carriers, that is, may shut down the M carriers based on the first indication information.

When a plurality of carriers configured by the access network device for the terminal device belong to the M carriers, and the plurality of carriers belong to one PA, the terminal device may further shut down the PA. Due to high power consumption of the PA, power consumption can be greatly reduced when the carriers in the bandwidths and the PA are shut down.

For detailed descriptions of step 1601 and step 1602, refer to related descriptions corresponding to FIG. 7, FIG. 14, and FIG. 15.

It should be understood that functions performed by the terminal device in the foregoing communication methods may also be performed by a module (for example, a chip) in the terminal device, and functions performed by the access network device in the foregoing communication methods may also be performed by a module (for example, a chip) in the access network device. Based on the foregoing network architecture, FIG. 17 is a diagram of a structure of a communication apparatus according to an embodiment of the disclosure. The communication apparatus may be a terminal device, may be an apparatus in a terminal device, or may be an apparatus that can be used together with a terminal device. In an implementation, the communication apparatus may include modules or units that are in one-to-one correspondence with the methods/operations/steps/actions performed by the terminal device in the foregoing method embodiments. The unit may be a hardware circuit, may be software, or may be implemented by a combination of a hardware circuit and software. In an implementation, as shown in FIG. 17, the communication apparatus may include a receiving unit 1701 and a shutdown unit 1702. The communication apparatus may further include an activation unit 1703 and an enabling unit 1704.

In one case, the receiving unit 1701 is configured to receive first indication information from an access network device, where the first indication information indicates to shut down M carrier groups, each of the M carrier groups includes one or more carriers, and M is an integer greater than or equal to 1.

The shutdown unit 1702 is configured to shut down carriers in the M carrier groups.

In an implementation, the receiving unit 1701 is further configured to receive second indication information from the access network device, where the second indication information indicates a total quantity of carrier groups, and the total quantity is greater than or equal to M.

In an implementation, the receiving unit 1701 is further configured to receive third indication information from the access network device, where the third indication information indicates a carrier group corresponding to a first carrier.

In an implementation, the third indication information includes an identifier of the carrier group corresponding to the first carrier, and the third indication information is carried in a system message, RRC signaling, a MAC CE, or DCI.

In an implementation, the receiving unit 1701 is further configured to receive configuration information from the access network device, where the configuration information is used to configure a candidate primary component carrier.

The activation unit 1703 configured to activate the candidate primary component carrier as a primary component carrier when there is a primary component carrier in the carriers included in the M carrier groups that are shut down.

In an implementation, the candidate primary component carrier is used for a master station or a secondary station.

In an implementation, the first indication information includes identifiers of the M carrier groups.

In an implementation, the first indication information is carried in a system message, RRC signaling, a MAC CE, or DCI.

In an implementation, the MAC CE corresponds to a predefined LCID.

In an implementation, the carrier included in the carrier group is associated with one or more RATs.

In an implementation, at least one of the M carrier groups includes a plurality of carriers.

In an implementation, that the receiving unit 1701 receives first indication information from an access network device may include:
receiving the first indication information from the access network device in a multicast manner or a broadcast manner.

In an implementation, that the receiving unit 1701 receives first indication information from an access network device may include:
receiving the first indication information from the access network device in a unicast manner.

In an implementation, carriers in a same carrier group belong to a same PA or band.

In an implementation, the receiving unit 1701 is further configured to receive fourth indication information from the access network device, where the fourth indication information indicates to enable N carrier groups, and N is an integer greater than or equal to 1.

The enabling unit 1704 is configured to enable carriers corresponding to the N carrier groups.

For more detailed descriptions of the receiving unit 1701, the shutdown unit 1702, the activation unit 1703, and the enabling unit 1704, directly refer to related descriptions of the terminal device in the method embodiments shown in FIG. 7, FIG. 14, and FIG. 15. Details are not described herein again.

In another case, the receiving unit 1701 is configured to receive first indication information from an access network device, where the first indication information indicates to shut down M carriers, the M carriers are associated with one or more RATs, and M is an integer greater than or equal to 1.

The shutdown unit 1702 is configured to shut down the M carriers.

In an implementation, the receiving unit 1701 is further configured to receive second indication information from the access network device, where the second indication information indicates a total quantity of carriers, and the total quantity is greater than or equal to M.

In an implementation, the receiving unit 1701 is further configured to receive configuration information from the access network device, where the configuration information is used to configure a candidate primary component carrier.

The activation unit 1703 is configured to activate the candidate primary component carrier as a primary component carrier when there is a primary component carrier in the M carriers that are shut down.

In an implementation, the candidate primary component carrier is used for a master station or a secondary station.

In an implementation, the first indication information includes identifiers of the M carriers, and the identifiers of the carriers are numbers obtained after the access network device uniformly numbers all the carriers.

In an implementation, the first indication information is carried in a system message, RRC signaling, a MAC CE, or DCI.

In an implementation, the MAC CE corresponds to a predefined LCID.

In an implementation, that the receiving unit 1701 receives first indication information from an access network device may include:
receiving the first indication information from the access network device in a multicast manner or a broadcast manner.

In an implementation, that the receiving unit 1701 receives first indication information from an access network device may include:
receiving the first indication information from the access network device in a unicast manner.

In an implementation, the receiving unit 1701 is further configured to receive third indication information from the access network device, where the third indication information indicates to enable N carriers, and N is an integer greater than or equal to 1.

The enabling unit 1704 is configured to enable the N carriers.

For more detailed descriptions of the receiving unit 1701, the shutdown unit 1702, the activation unit 1703, and the enabling unit 1704, directly refer to related descriptions of the terminal device in the method embodiment shown in FIG. 16. Details are not described herein again.

Based on the foregoing network architecture, FIG. 18 is a diagram of a structure of another communication apparatus according to an embodiment of the disclosure. The communication apparatus may be an access network device, an apparatus in an access network device, or an apparatus that can be used together with an access network device. In an implementation, the communication apparatus may include modules or units that are in one-to-one correspondence with the methods/operations/steps/actions performed by the access network device in the foregoing method embodiments. The unit may be a hardware circuit, may be software, or may be implemented by a combination of a hardware circuit and software. In an implementation, as shown in FIG. 18, the communication apparatus may include a sending unit 1801 and a processing unit 1802. The processing unit 1802 is configured to control the sending unit 1801 to send signaling/data.

In one case, the sending unit 1801 is configured to send first indication information, where the first indication information indicates to shut down M carrier groups, each of the M carrier groups includes one or more carriers, and M is an integer greater than or equal to 1.

In an implementation, the sending unit 1801 is further configured to send second indication information, where the second indication information indicates a total quantity of carrier groups, and the total quantity is greater than or equal to M.

In an implementation, the sending unit 1801 is further configured to send third indication information, where the third indication information indicates a carrier group corresponding to a first carrier.

In an implementation, the third indication information includes an identifier of the carrier group corresponding to the first carrier, and the third indication information is carried in a system message, RRC signaling, a MAC CE, or DCI.

In an implementation, the sending unit 1801 is further configured to send configuration information, where the configuration information is used to configure a candidate primary component carrier.

In an implementation, the candidate primary component carrier is used for a master station or a secondary station.

In an implementation, the first indication information includes identifiers of the M carrier groups.

In an implementation, the first indication information is carried in a system message, RRC signaling, a MAC CE, or DCI.

In an implementation, the MAC CE corresponds to a predefined LCID.

In an implementation, the carrier included in the carrier group is associated with one or more RATs.

In an implementation, at least one of the M carrier groups includes a plurality of carriers.

In an implementation, that the sending unit 1801 sends first indication information includes:
sending the first indication information in a multicast manner or a broadcast manner.

In an implementation, that the sending unit 1801 sends first indication information includes:
sending the first indication information to the terminal device in a unicast manner.

In an implementation, carriers in a same carrier group belong to a same PA or band.

In an implementation, the sending unit 1801 is further configured to send fourth indication information, where the fourth indication information indicates to enable N carrier groups, and N is an integer greater than or equal to 1.

For detailed descriptions of the sending unit 1801 and the processing unit 1802, directly refer to related descriptions of the access network device in the method embodiments shown in FIG. 7, FIG. 14, and FIG. 15. Details are not described herein again.

In another case, the sending unit 1801 is configured to send first indication information, where the first indication information indicates to shut down M carriers, the M carriers are associated with one or more RATs, and M is an integer greater than or equal to 1.

In an implementation, the sending unit 1801 is further configured to send second indication information, where the second indication information indicates a total quantity of carriers, and the total quantity is greater than or equal to M.

In an implementation, the sending unit 1801 is further configured to send configuration information, where the configuration information is used to configure a candidate primary component carrier.

In an implementation, the candidate primary component carrier is used for a master station or a secondary station.

In an implementation, the first indication information includes identifiers of the M carriers, and the identifiers of the carriers are numbers obtained after the access network device uniformly numbers all the carriers.

In an implementation, the first indication information is carried in a system message, RRC signaling, a MAC CE, or DCI.

In an implementation, the MAC CE corresponds to a predefined LCID.

In an implementation, that the sending unit 1801 sends first indication information includes:
sending the first indication information in a multicast manner or a broadcast manner.

In an implementation, that the sending unit 1801 sends first indication information includes:
sending the first indication information to the terminal device in a unicast manner.

In an implementation, the sending unit 1801 is further configured to send third indication information, where the third indication information indicates to enable N carriers, and N is an integer greater than or equal to 1.

For detailed descriptions of the sending unit 1801 and the processing unit 1802, directly refer to related descriptions of the access network device in the method embodiment shown in FIG. 16. Details are not described herein again.

It should be understood that the foregoing units may be independent of each other, or may be integrated. For example, the shutdown unit, the activation unit, and the enabling unit may be independent of each other, or may be integrated into a processing unit.

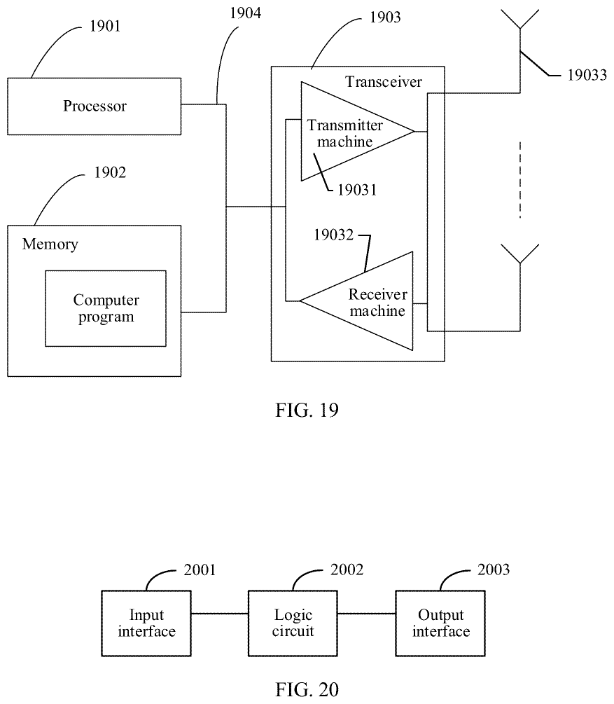

Based on the foregoing network architecture, FIG. 19 is a diagram of a structure of still another communication apparatus according to an embodiment of the disclosure. As shown in FIG. 19, the communication apparatus may include a processor 1901, an optional memory 1902, a transceiver 1903, and a bus 1904. The memory 1902 may exist independently, and may be connected to the processor 1901 through the bus 1904. Alternatively, the memory 1902 may be integrated with the processor 1901. The bus 1904 is configured to implement connections between these components. In a case, as shown in FIG. 17, the transceiver 1903 may include a transmitter machine 19031, a receiver machine 19032, and an antenna 19033. In another case, the transceiver 1903 may include a transmitter (namely, an output interface) and a receiver (namely, an input interface). The transmitter may include a transmitter machine and an antenna, and the receiver may include a receiver machine and an antenna.

The communication apparatus may be a terminal device, or may be a module in the terminal device. When a computer program stored in the memory 1902 is executed, the processor 1901 is configured to control the receiving unit 1701 to perform the operations performed in the foregoing embodiments, the processor 1901 is further configured to perform the operations performed by the shutdown unit 1702, the activation unit 1703, and the enabling unit 1704 in the foregoing embodiments, and the transceiver 1903 is configured to perform the operations performed by the receiving unit 1701 in the foregoing embodiments. The communication apparatus may be further configured to perform various methods performed by the terminal device in the method embodiments in FIG. 7 and FIG. 14 to FIG. 16. Details are not described again.

The communication apparatus may be an access network device, or may be a module in an access network device. When a computer program stored in the memory 1902 is executed, the processor 1901 is configured to control the sending unit 1801 to perform the operations performed in the foregoing embodiments, and the processor 1901 is further configured to perform the operations performed by the processing unit 1802 in the foregoing embodiments. The transceiver 1903 is configured to perform the operations performed by the sending unit 1801 in the foregoing embodiments. The communication apparatus may be further configured to perform various methods performed by the access network device in the method embodiments in FIG. 7 and FIG. 14 to FIG. 16. Details are not described again.

Based on the foregoing network architecture, FIG. 20 is a diagram of a structure of yet another communication apparatus according to an embodiment of the disclosure. As shown in FIG. 20, the communication apparatus may include an input interface 2001, a logic circuit 2002, and an output interface 2003. The input interface 2001 is connected to the output interface 2003 by using the logic circuit 2002. The input interface 2001 is configured to receive information from another communication apparatus, and the output interface 2003 is configured to output, schedule, or send information to the another communication apparatus. The logic circuit 2002 is configured to: perform an operation other than operations of the input interface 2001 and the output interface 2003, for example, implement functions implemented by the processor 1901 in the foregoing embodiment. The communication apparatus may be a terminal device (or a module in a terminal device), or may be an access network device (or a module in an access network device). For more detailed descriptions of the input interface 2001, the logic circuit 2002, and the output interface 2003, directly refer to related descriptions of the terminal device or the access network device in the foregoing method embodiments. Details are not described herein again.

It should be understood that the foregoing modules may be independent of each other, or may be integrated. For example, a transmitter machine, a receiver machine, and an antenna may be independent of each other, or may be integrated into a transceiver. For another example, the input interface and the output interface may be independent of each other, or may be integrated into a communication interface.

An embodiment of the disclosure further discloses a computer-readable storage medium. The computer-readable storage medium stores a computer program or computer instructions. When the computer program or the computer instructions are run on a computer, the methods in the foregoing method embodiments are performed.

An embodiment of the disclosure further discloses a computer program product including a computer program or computer instructions. When the computer program or the computer instructions are run on a computer, the methods in the foregoing method embodiments are performed.

An embodiment of the disclosure further discloses a communication system. The communication system may include a core network device, an access network device, and a terminal device. For descriptions, refer to the foregoing communication methods.

In the foregoing implementations, the objectives, technical solutions, and beneficial effects of the disclosure are further described in detail. It should be understood that the foregoing descriptions are merely implementations of the disclosure, but are not intended to limit the protection scope of the disclosure. Any modification, equivalent replacement, improvement, or the like made based on the technical solutions of the disclosure shall fall within the protection scope of the disclosure.

What is claimed is:

1. A communication method, comprising:
receiving first indication information from an apparatus at a network side, the first indication information indicating to shut down M carrier groups, each carrier group of the M carrier groups comprising one or more carriers, M being an integer greater than or equal to 1, and the first indication information comprising identifiers of the M carrier groups; and
shutting down carriers in the M carrier groups.

2. The method according to claim 1, further comprising:
receiving second indication information from the apparatus, wherein the second indication information indicates a total quantity of carrier groups, and the total quantity is greater than or equal to M.

3. The method according to claim 1, further comprising:
receiving configuration information from the apparatus, wherein the configuration information is used to configure a candidate primary component carrier; and
activating the candidate primary component carrier as a primary component carrier when there is a primary component carrier in the carriers comprised in the M carrier groups that are shut down.

4. The method according to claim 3, wherein the candidate primary component carrier is used for a master station or a secondary station.

5. The method according to claim 1, further comprising:
receiving third indication information from the apparatus, wherein the third indication information indicates a carrier group corresponding to a first carrier.

6. The method according to claim 5, wherein the third indication information comprises an identifier of the carrier group corresponding to the first carrier.

7. The method according to claim 5, wherein the third indication information is carried in one of: a system message, radio resource control (RRC) signaling, a media access control element (MAC CE), or downlink control information (DCI).

8. The method according to claim 1, wherein the first indication information is carried in one of:
a system message, a radio resource control (RRC) signaling, a media access control element (MAC CE), or downlink control information (DCI).

9. The method according to claim 8, wherein the MAC CE corresponds to a predefined logical channel identifier (LCID).

10. The method according to claim 1, wherein one carrier group of the M carrier groups comprises a first carrier associated with a first radio access technology (RAT) and a second carrier associated with a second RAT.

11. The method according to claim 1, wherein carriers in a first carrier group of the M carrier groups belong to a same power amplifier (PA) or bandwidth.

12. The method according to claim 1, further comprising:
receiving fourth indication information from the apparatus, wherein the fourth indication information indicates to enable N carrier groups, and N is an integer greater than or equal to 1; and
enabling carriers corresponding to the N carrier groups.

13. An apparatus, comprising:
a memory storing instructions; and
a processing circuit in communication with the memory, the processing circuit operates, upon execution of the instructions, to cause the apparatus to:
receive first indication information from another apparatus at a network side, the first indication information indicating to shut down M carrier groups, each carrier group of the M carrier groups comprising one or more carriers, M being an integer greater than or equal to 1, and the first indication information comprising identifiers of the M carrier groups; and
shut down carriers in the M carrier groups.

14. The apparatus according to claim 13, wherein the processing circuit is further configured to operate, upon execution of the instructions, to cause the apparatus to:
receive second indication information from the another apparatus, wherein the second indication information indicates a total quantity of carrier groups, and the total quantity is greater than or equal to M.

15. The apparatus according to claim 13, wherein the processing circuit is further configured to operate, upon execution of the instructions, to cause the apparatus to:
receive configuration information from the another apparatus, wherein the configuration information is used to configure a candidate primary component carrier; and
activate the candidate primary component carrier as a primary component carrier when there is a primary component carrier in the carriers comprised in the M carrier groups that are shut down.

16. The apparatus according to claim 15, wherein the candidate primary component carrier is used for a master station or a secondary station.

17. The apparatus according to claim 13, wherein the processing circuit is further configured to operate, upon execution of the instructions, to cause the apparatus to:
receive third indication information from the another apparatus, wherein the third indication information indicates a carrier group corresponding to a first carrier.

18. The apparatus according to claim 17, wherein the third indication information comprises an identifier of the carrier group corresponding to the first carrier, and the third indication information is carried in one of: a system message, radio resource control (RRC) signaling, a media access control control element (MAC CE), or downlink control information (DCI).

19. The apparatus according to claim 13, wherein the first indication information is carried in one of: a system message, a radio resource control (RRC) signaling, a media access control element (MAC CE), or downlink control information (DCI).

20. A non-transitory computer-readable storage media storing computer instructions that run a processing circuit, upon execution of the instructions, to cause an apparatus to:
receive first indication information from an apparatus at a network side, the first indication information indicating to shut down M carrier groups, each carrier group of the M carrier groups comprising one or more carriers, M being an integer greater than or equal to 1, and the first indication information comprising identifiers of the M carrier groups; and
shut down carriers in the M carrier groups.
